(19) United States
(12) Patent Application Publication
(10) Pub. No.: US 2025/0147211 A1
(43) Pub. Date: May 8, 2025

(54) LAMINATE, MANUFACTURING METHOD OF LAMINATE, AND VIRTUAL REALITY DISPLAY APPARATUS

(71) Applicant: FUJIFILM Corporation, Tokyo (JP)

(72) Inventors: Yoshinori MAEDA, Kanagawa (JP); Hideki KANEIWA, Kanagawa (JP)

(73) Assignee: FUJIFILM Corporation, Tokyo (JP)

(21) Appl. No.: 19/013,665

(22) Filed: Jan. 8, 2025

Related U.S. Application Data
(63) Continuation of application No. PCT/JP2023/028391, filed on Aug. 3, 2023.

(30) Foreign Application Priority Data
Aug. 30, 2022 (JP) 2022-136601
Mar. 23, 2023 (JP) 2023-047080
Jun. 23, 2023 (JP) 2023-103352

(51) Int. Cl. G02B 5/22; G02B 1/14

(52) U.S. Cl. CPC G02B 5/223; G02B 1/14

(57) ABSTRACT

A laminate, a manufacturing method of a laminate, and a virtual reality display apparatus, in which display performance of the virtual reality display apparatus can be improved in a case where the laminate including a light absorption anisotropic layer is introduced into the virtual reality display apparatus. The laminate includes an alignment film and a light absorption anisotropic layer provided on the alignment film, in which the light absorption anisotropic layer contains a liquid crystal compound and a dichroic substance, and a film thickness variation of the alignment film is 10% or less.

### CROSS-REFERENCE TO RELATED APPLICATIONS

This application is a Continuation of PCT International Application No. PCT/JP2023/028391 filed on Aug. 3, 2023, which was published under PCT Article 21(2) in Japanese, and which claims priority under 35 U.S.C. § 119(a) to Japanese Patent Application No. 2022-136601 filed on Aug. 30, 2022, Japanese Patent Application No. 2023-047080 filed on Mar. 23, 2023, and Japanese Patent Application No. 2023-103352 filed on Jun. 23, 2023. The above applications are hereby expressly incorporated by reference, in their entirety, into the present application.

### BACKGROUND OF THE INVENTION

### 1. Field of the Invention

The present invention relates to a laminate, a manufacturing method of a laminate, and a virtual reality display apparatus.

### 2. Description of the Related Art

In recent years, a virtual reality display apparatus has been known as a display device which can obtain a realistic effect as if entering a virtual world by wearing a dedicated headset on a head and visually recognizing a video displayed through a lens.

Such a virtual reality display apparatus generally includes an image display panel and a Fresnel lens, but since a distance from the image display panel to the Fresnel lens is large, the headset is thick, and there is a problem that wearability is deteriorated.

In consideration of the above problem, JP2020-519964A discloses a lens configuration called a pancake lens, including an image display panel, a reflective type polarizer, and a half mirror, in which the entire thickness of a headset is reduced by reciprocating rays emitted from the image display panel between the reflective type polarizer and the half mirror.

### SUMMARY OF THE INVENTION

The present inventors have found that, in the virtual reality display apparatus disclosed in JP2020-519964A and the like, depending on the optical member used, a part of ray emitted from the image display panel is reflected in an undesirable manner, the virtual image is distorted, and the image is recognized as a magnified and distorted image, which causes a problem of deteriorating display performance.

In addition, the present inventors have found that, in a case where a light absorption anisotropic layer containing a liquid crystal compound and a dichroic substance is used as an absorption type linear polarizer in a case of introducing the absorption type linear polarizer into a virtual reality display apparatus, a problem of deterioration in durability occurs in a case where at least one surface of the light absorption anisotropic layer and an adhesive layer are provided to be adjacent to each other, and thus it is necessary to introduce the light absorption anisotropic layer in a state (laminate) of being laminated with another layer (for example, an alignment film).

Therefore, an object of the present invention is to provide a laminate, a manufacturing method of a laminate, and a virtual reality display apparatus, in which display performance of the virtual reality display apparatus can be improved in a case where the laminate including a light absorption anisotropic layer is introduced into the virtual reality display apparatus.

As a result of intensive studies to achieve the above-described objects, the present inventors have found that, in a case where a laminate including an alignment film, which satisfies a predetermined film thickness variation, and a light absorption anisotropic layer is introduced into a virtual reality display apparatus, the display performance of the virtual reality display apparatus can be improved, and have completed the present invention.

That is, the present inventors have found that the above-described object can be achieved by employing the following configurations.

[1]A laminate comprising:
an alignment film; and
a light absorption anisotropic layer provided on the alignment film,
in which the light absorption anisotropic layer contains a liquid crystal compound and a dichroic substance, and
a film thickness variation of the alignment film is 10% or less.

[2] The laminate according to [1],
in which the dichroic substance contains a dichroic azo coloring agent compound having a thienothiazole skeleton.

[3] The laminate according to [1] or [2],
in which a content of the dichroic substance contained in the light absorption anisotropic layer is 40 to 250 mg/cm³.

[4] The laminate according to any one of [1] to [3],
in which the alignment film contains a polymer compound, and
in a case where a secondary ion intensity derived from the polymer compound in the alignment film is measured by time-of-flight secondary ion mass spectrometry while irradiating the alignment film with an ion beam from a surface of the alignment film on a light absorption anisotropic layer side toward a surface opposite to the light absorption anisotropic layer, a maximum value of the secondary ion intensity derived from the polymer compound is present in a region from the surface opposite to the light absorption anisotropic layer to a position at a thickness of 100 nm.

[5] The laminate according to [4],
in which the polymer compound has a repeating unit represented by Formula (2) described later.

[6] The laminate according to any one of [1] to [5], further comprising:
a protective layer on a side of the light absorption anisotropic layer opposite to the alignment film,
in which an oxygen permeability coefficient of the protective layer is 200 cc/m²·day·atm or less.

[7] The laminate according to [6],
in which the protective layer consists of a polyvinyl alcohol-based resin film.

[8] The laminate according to any one of [1] to [5],
in which the alignment film, the light absorption anisotropic layer, a pressure-sensitive adhesive layer, and a retardation layer are provided adjacent to each other in this order.

[9] The laminate according to [8],
in which an oxygen permeability coefficient of the pressure-sensitive adhesive layer is 200 cc/m²·day·atm or less.

[10] The laminate according to any one of [1] to [9],
in which the laminate has a curved surface shape.

[11]A manufacturing method of a laminate, which is a method for manufacturing the laminate according to any one of [1] to [10], the manufacturing method comprising:
an alignment film-forming step of forming an alignment film on a base material using a composition for forming an alignment film;
a light absorption anisotropic layer-forming step of, after the alignment film-forming step, forming a light absorption anisotropic layer on the alignment film using a composition for forming a light absorption anisotropic layer, which contains a liquid crystal compound and a dichroic substance; and
a base material peeling step of, after the light absorption anisotropic layer-forming step, peeling off the base material to manufacture a laminate of the alignment film and the light absorption anisotropic layer.

[12] The manufacturing method of a laminate according to [11],
in which the composition for forming an alignment film contains a polymer compound, and
an absolute value of a difference between an SP value of the polymer compound and an SP value of the base material is 1.7 MPa^{1/2} or less.

[13] The manufacturing method of a laminate according to [11] or [12],
in which a viscosity of the composition for forming an alignment film at 25° C. is 2 mPa·s or more and less than 10 mPa·s.

[14] The manufacturing method of a laminate according to any one of [11] to [13],
in which the alignment film-forming step includes a drying treatment of drying a coating film obtained by applying the composition for forming an alignment film onto the base material, the coating film having a concentration of solid contents of 60% or less, with wind having a wind speed of 2 m/s or less.

[15]A virtual reality display apparatus comprising, in the following order:
an image display panel;
a first absorption type linear polarizer;
a first retardation layer;
a reflective type circular polarizer;
a half mirror;
a second retardation layer; and
a second absorption type linear polarizer,
in which the second absorption type linear polarizer is the laminate according to any one of [1] to [10].

According to the present invention, it is possible to provide a laminate, a manufacturing method of a laminate, and a virtual reality display apparatus, in which display performance of the virtual reality display apparatus can be improved in a case where the laminate including a light absorption anisotropic layer is introduced into the virtual reality display apparatus.

### BRIEF DESCRIPTION OF THE DRAWINGS

FIG. 1 is a conceptual diagram for describing a film thickness variation of an alignment film.

FIG. 2 is a schematic cross-sectional view showing an example of a virtual reality display apparatus according to an embodiment of the present invention.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

Any numerical range expressed using “to” in the present specification refers to a range including the numerical values before and after the “to” as a lower limit value and an upper limit value, respectively.

In addition, in the present specification, substances corresponding to respective components may be used alone or in combination of two or more kinds thereof. Here, in a case where two or more types of substances are used in combination for each component, the content of the component refers to a total content of the substances used in combination unless otherwise specified.

In addition, in this specification, “(meth)acrylic” is a notation representing “acrylic” or “methacrylic”.

In the present specification, Re (λ) and Rth (λ) represent an in-plane retardation and a thickness-direction retardation at a wavelength λ, respectively. Unless otherwise specified, the wavelength λ refers to 550 nm.

In addition, in the present specification, Re (λ) and Rth (λ) are values measured at the wavelength λ using AxoScan (manufactured by Axometrics, Inc.).

Specifically, by inputting an average refractive index ((nx+ny+nz)/3) and a film thickness (d (μm)) in AxoScan,
an in-plane slow axis direction (°),
Re (λ)=R0(λ), and
Rth (λ)=((nx+ny)/2−nz)×d are calculated.

Although R0 (λ) is represented as a numerical value calculated by AxoScan, it means Re (λ).

### [Laminate]

The laminate according to the embodiment of the present invention is a laminate including an alignment film and a light absorption anisotropic layer provided on the alignment film.

In addition, the light absorption anisotropic layer of the laminate according to the embodiment of the present invention contains a liquid crystal compound and a dichroic substance.

In addition, a film thickness variation of the alignment film of the laminate according to the embodiment of the present invention is 10% or less.

Here, the coefficient of variation of the alignment film refers to a value calculated by the following procedure.

First, a reflectivity of a laminate including an alignment film (for example, a laminate including a base material, an alignment film, and a light absorption anisotropic layer) is measured at a lens magnification of 25 times using an interference film thickness measuring device (for example, FE3000 manufactured by Otsuka Electronics Co, Ltd.). In the measurement, 101 points are measured at any distance of 10 cm at a pitch of 1 mm. In addition, in a case where the measurement target has a curved surface shape or a sample size is 10 cm or less, in the measurement, a straight line is selected such that a distance between the object and an intersection of the straight line is longest in a case where the straight line is superimposed on the object, and thicknesses of each point obtained by dividing the straight line into 100 equal parts are measured.

Next, a refractive index of each layer of the laminate including the alignment film at a wavelength of 400 nm to 800 nm is calculated by a base analysis method, and the calculated refractive index is fitted at a wavelength of 400 nm to 800 nm by a fast Fourier transform (FFT) method to calculate the film thickness. The unit of the film thickness is [nm].

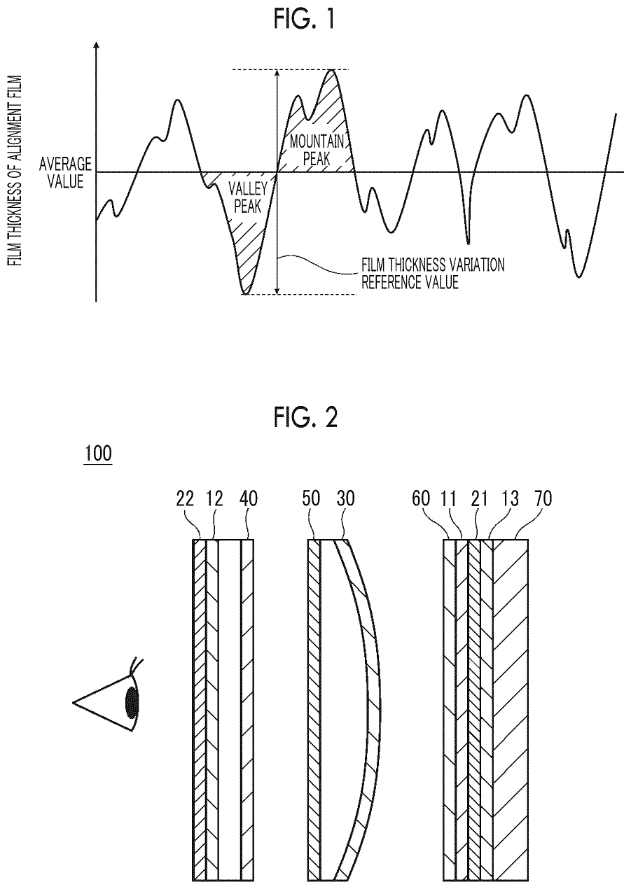

Next, regarding a graph (for example, FIG. 1) of the film thickness of the alignment film obtained by the fitting, a region where the film thickness is thicker than an average film thickness (average value) is defined as a mountain peak, a region where the film thickness is thinner than the average thickness (average value) is defined as a valley peak, the maximum value of the mountain peak is defined as a mountain peak thickness, the minimum value of the valley peak is defined as a valley peak thickness, and a difference between the mountain peak thickness and the valley peak thickness adjacent to each other is defined as a film thickness variation reference value of each element. The film thickness variation of all adjacent elements is calculated, and the maximum value thereof is calculated as the film thickness variation reference value of the alignment film.

In a case where the measurement with the interference film thickness measuring device is difficult, the thickness can also be measured by morphological observation with a scanning electron microscope (SEM). In this case, a cross section is obtained by cutting the laminate including the light absorption anisotropic layer with a microtome, and the cross section is observed with a SEM at an appropriate magnification (20,000 to 50,000 times) to obtain the film thickness of the light absorption anisotropic layer. In addition, in order to facilitate the observation, the sample may be subjected to an appropriate treatment such as carbon vapor deposition and etching. An acceleration voltage is optimized under the condition of 1 kV to 10 kV In addition, the laminate may be peeled off from a base material such as a lens, or the cross section including the base material may be cut. In a case where the laminate is viewed in a plan view, 9 points excluding end parts are measured by dividing the straight line passing through the in-plane center of gravity into 10 equal parts, and the average film thickness of the alignment film and the film thickness variation reference value of the alignment film are calculated in the same manner as described above.

Next, the film thickness variation of the alignment film is calculated from the following expression using the calculated film thickness variation reference value of the alignment film.

Film thickness variation of alignment film (%)=(Film thickness variation reference value of alignment film)+(Average film thickness of alignment film)

In a case where the thickness measurement can be performed by both the interference film thickness measuring device and the morphology observation with a SEM, the film thickness variation value is determined based on the measurement result of the interference film thickness measuring device.

As described above, in a case where the laminate according to the embodiment of the present invention, which includes the alignment film having a film thickness variation of 10% or less and the light absorption anisotropic layer, is introduced into the virtual reality display apparatus, display performance of the virtual reality display apparatus can be improved.

This is considered to be because, by using the alignment film having a film thickness variation of 10% or less, undesirable reflection by a part of ray emitted from the display panel is suppressed, and distortion of the virtual image is suppressed. The effect of improving the display performance by focusing on the alignment film among a large number of optical members used in the virtual reality display apparatus and setting the film thickness variation to be 10% or less is a significant effect (an effect which is not predictable).

Hereinafter, the alignment film and the light absorption anisotropic layer included in the laminate according to the embodiment of the present invention will be described.

### [Alignment Film]

As described above, the alignment film included in the laminate according to the embodiment of the present invention is an alignment film in which the film thickness variation is 10% or less, preferably an alignment film in which the film thickness variation is more than 0% and 6% or less, and more preferably an alignment film in which the film thickness variation is more than 0% and 3% or less.

The alignment film included in the laminate according to the embodiment of the present invention is not particularly limited as long as the film thickness variation is 10% or less, and may be a rubbing-treated alignment film formed by a rubbing treatment or a photo-alignment film formed by irradiation with light as long as the light absorption anisotropic layer described later can be brought into a desired alignment state. Among these, a photo-alignment film is preferable.

### <Photo-Alignment Film>

A photo-alignment compound used for the photo-alignment film formed by irradiation with light is described in a plurality of documents. In the present invention, preferred examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; aromatic ester compounds described in JP2002-229039A; maleimide and/or alkenyl-substituted nadimide compounds having a photo-alignment unit, described in JP2002-265541A and JP2002-317013A; photo-crosslinkable silane derivatives described in JP4205195B and JP4205198B; and photo-crosslinkable polyimides, polyamides, or esters described in JP2003-520878A, JP2004-529220A, and JP4162850B. Azo compounds, photo-crosslinkable polyimides, polyamides, or esters are more preferable.

Among these, a photosensitive compound having a photo-aligned group, which undergoes at least one of dimerization or isomerization by action of light is preferably used as the photo-alignment compound.

In addition, examples of the photo-aligned group include a group having a cinnamic acid (cinnamoyl) structure (skeleton), a group having a coumarin structure (skeleton), a group having a chalcone structure (skeleton), a group having a benzophenone structure (skeleton), and a group having an anthracene structure (skeleton). Among these groups, a group having a cinnamoyl structure or a group having a coumarin structure is preferable, and a group having a cinnamoyl structure is more preferable.

In addition, the photosensitive compound having the above-described photo-aligned group may further have a crosslinkable group.

As the above-described crosslinkable group, a thermally crosslinking group which causes a curing reaction due to action of heat or a photo-crosslinkable group which causes a curing reaction due to action of light is preferable, and the crosslinkable group may be a crosslinkable group which has both the thermally crosslinking group and the photo-crosslinkable group.

Examples of the above-described crosslinkable group include at least one selected from the group consisting of an epoxy group, an oxetanyl group, a group represented by —NH—CH₂—O—R (R represents a hydrogen atom or an alkyl group having 1 to 20 carbon atoms), a group having an ethylenically unsaturated double bond, and a blocked isocyanate group. Among these, an epoxy group, an oxetanyl group, or a group having an ethylenically unsaturated double bond is preferable.

A 3-membered cyclic ether group is also referred to as the epoxy group, and a 4-membered cyclic ether group is also referred to as the oxetanyl group.

In addition, specific examples of the group having an ethylenically unsaturated double bond include a vinyl group, an allyl group, a styryl group, an acryloyl group, and a methacryloyl group, and an acryloyl group or a methacryloyl group is preferable.

The photo-alignment film formed of the above-described material is irradiated with linearly polarized light or non-polarized light to manufacture a photo-alignment film.

In the present specification, the “irradiation with linearly polarized light” and the “irradiation with non-polarized light” are operations for causing a photo-reaction in the photo-alignment material. A wavelength of the light to be used varies depending on the photo-alignment material to be used, and is not particularly limited as long as the wavelength is required for the photo-reaction. A peak wavelength of the light to be used for irradiation with light is preferably 200 nm to 700 nm, and ultraviolet light having a peak wavelength of 400 nm or less is more preferable.

Examples of a light source used for the light irradiation include commonly used light sources, for example, lamps such as a tungsten lamp, a halogen lamp, a xenon lamp, a xenon flash lamp, a mercury lamp, a mercury xenon lamp, or a carbon arc lamp, various lasers [such as a semiconductor laser, a helium neon laser, an argon ion laser, a helium cadmium laser, and a yttrium aluminum garnet (YAG) laser], a light emitting diode, and a cathode ray tube.

As a method of obtaining the linearly polarized light, a method of using a polarizing plate (for example, iodine polarizing plate, dichroic coloring agent polarizing plate, and wire grid polarizing plate), a method of using a prismatic element (for example, Glan-Thomson prism) or a reflective type polarizer using Brewster's angle, or a method of using light emitted from a polarized laser light source can be adopted. In addition, by using a filter, a wavelength conversion element, or the like, only light having a required wavelength may be radiated selectively.

In a case where light to be applied is the linearly polarized light, a method of applying light vertically or obliquely to the upper surface of the alignment film or the surface of the alignment film from the rear surface is employed. An incidence angle of light varies depending on the photo-alignment material, but is preferably 0° to 90° (vertical) and more preferably 400 to 90°.

In a case where the light to be applied is the non-polarized light, the alignment film is irradiated with the non-polarized light obliquely. An incidence angle is preferably 10° to 80°, more preferably 20° to 60°, and still more preferably 30° to 50°.

The irradiation time is preferably 1 minute to 60 minutes and more preferably 1 minute to 10 minutes.

In a case where patterning is required, a method of performing irradiation with light using a photomask as many times as necessary for pattern preparation or a method of writing a pattern by laser light scanning can be employed.

In the present invention, the above-described alignment film is preferably a photo-alignment film formed of a composition for forming an alignment film, which contains the photo-alignment compound (particularly, the photosensitive compound having the photo-aligned group).

In addition, in the present invention, from the viewpoint that peelability of the above-described alignment film with any member (for example, a base material) provided on a side of the alignment film opposite to the light absorption anisotropic layer can be freely controlled, it is preferable that the above-described composition for forming an alignment film contains a polymerization initiator.

The polymerization initiator is not particularly limited, and examples thereof include a photoradical polymerization initiator and a thermal cationic polymerization initiator, depending on the type of polymerization reaction.

The polymerization initiator is preferably a photoradical polymerization initiator capable of initiating a polymerization reaction by ultraviolet irradiation.

Examples of the photoradical polymerization initiator include an α-carbonyl compound, acyloin ether, an α-hydrocarbon-substituted aromatic acyloin compound, a polynuclear quinone compound, a combination of a triarylimidazole dimer and p-aminophenyl ketone, an acridine and phenazine compound, an oxadiazole compound, and an acylphosphine oxide compound.

In a case where the above-described composition for forming an alignment film contains a photoradical polymerization initiator, a content of the photoradical polymerization initiator is preferably 0.1% to 10% by mass, and more preferably 1% to 5% by mass with respect to the total solid content of the composition for forming an alignment film.

In addition, in a case where the above-described composition for forming an alignment film contains a thermal cationic polymerization initiator, a content of the thermal cationic polymerization initiator is preferably 1% to 30% by mass, and more preferably 4% to 20% by mass with respect to the total solid content of the composition for forming an alignment film.

Furthermore, in the present invention, it is preferable that the above-described composition for forming an alignment film contains a solvent.

Examples of the solvent include ketones (for example, acetone, 2-butanone, methyl isobutyl ketone, cyclopentanone, and cyclohexanone), ethers (for example, dioxane and tetrahydrofuran), aliphatic hydrocarbons (for example, hexane), alicyclic hydrocarbons (for example, cyclohexane), aromatic hydrocarbons (for example, toluene, xylene, and trimethylbenzene), halogenated carbons (for example, dichloromethane, dichloroethane, dichlorobenzene, and chlorotoluene), esters (for example, methyl acetate, ethyl acetate, and butyl acetate), water, alcohols (for example, ethanol, isopropanol, butanol, and cyclohexanol), cellosolves (for example, methyl cellosolve and ethyl cellosolve), cellosolve acetates, sulfoxides (for example, dimethyl sulfoxide), and amides (for example, dimethylformamide and dimethylacetamide).

The solvents may be used alone or in combination of two or more kinds thereof.

### <Polymer Compound>

In the present invention, from the viewpoint of improving peelability of the above-described alignment film with any member (for example, a base material) provided on a side of the alignment film opposite to the light absorption anisotropic layer, it is preferable that the above-described alignment film contains a polymer compound, and in a case where a secondary ion intensity derived from the polymer compound in the alignment film is measured by time-of-flight secondary ion mass spectrometry (TOF-SIMS) while irradiating the alignment film with an ion beam from a surface of the alignment film on a light absorption anisotropic layer side toward a surface opposite to the light absorption anisotropic layer, the maximum value of the secondary ion intensity derived from the polymer compound is present in a region from the surface opposite to the light absorption anisotropic layer to a position at a thickness of 100 nm.

Here, in a case where the above-described alignment film contains two or more kinds of polymer compounds, at least one kind of the polymer compounds may be unevenly distributed on the side opposite to the light absorption anisotropic layer.

In the following description, the fact that the maximum value of the secondary ion intensity derived from the polymer compound is present in a region from the surface opposite to the light absorption anisotropic layer to a position at a thickness of 100 nm will also be simply abbreviated as “polymer compound is unevenly distributed on the side opposite to the light absorption anisotropic layer”.

In addition, examples of a method for confirming that the polymer compound is unevenly distributed on the side opposite to the light absorption anisotropic layer include a method of evaluating a position at which the secondary ion intensity derived from the polymer compound exhibits the maximum value, using TOF-SIMS. Specifically, in a case of analyzing components in a depth direction of the laminate by TOF-SIMS while irradiating the laminate with an ion beam, a series of operations of performing component analysis in a surface depth region of 1 to 2 nm, further digging from 1 nm to several hundreds of nm in the depth direction, and performing component analysis in a surface depth region of 1 to 2 nm are repeated, whereby it is possible to check the position at which the ion intensity exhibits the maximum value.

In the present invention, from the reason that the peelability of the above-described alignment film with any member (for example, a base material) provided on a side of the alignment film opposite to the light absorption anisotropic layer is improved, the above-described polymer compound preferably has a repeating unit represented by Formula (2) described later.

In addition, from the viewpoint that the peelability of the above-described alignment film with any member (for example, a base material) provided on a side of the alignment film opposite to the light absorption anisotropic layer can be freely controlled, the above-described polymer compound is preferably at least one specific compound selected from the group consisting of a polymerizable polymer having a polymerizable group in a side chain and a polymer of the polymerizable polymer.

### (Specific Compound)

The polymerizable group included in the side chain of the polymerizable polymer which is one aspect of the specific compound is not particularly limited, but is preferably a polymerizable group capable of radical polymerization or cationic polymerization.

Here, examples of the radically polymerizable group (photo-crosslinkable group) include a (meth)acryloyl group, an acrylamide group, a vinyl group, a styryl group, and an allyl group.

In addition, examples of the cationically polymerizable group (thermally crosslinking group) include a vinyl ether group, an oxiranyl group, and an oxetanyl group.

In the present invention, from the viewpoint of easily controlling the peelability of the above-described alignment film with any member (for example, a base material) provided on a side of the alignment film opposite to the light absorption anisotropic layer, the polymerizable group is preferably a (meth)acryloyl group.

In addition, in the present invention, it is preferable that the above-described polymerizable polymer does not have the photo-aligned group described in the photo-alignment compound above.

A structure of a main chain of the above-described polymerizable polymer is not particularly limited, and examples thereof include known structures. For example, a skeleton selected from the group consisting of a (meth)acrylic skeleton, a styrene-based skeleton, a siloxane-based skeleton, a cycloolefin-based skeleton, a methylpentene-based skeleton, an amide-based skeleton, and an aromatic ester-based skeleton is preferable.

Among these, a skeleton selected from the group consisting of a (meth)acrylic skeleton, a siloxane-based skeleton, and a cycloolefin-based skeleton is more preferable, and a (meth)acrylic skeleton is still more preferable.

In the present invention, from the reason that the peelability of the above-described alignment film with any member (for example, a base material) provided on a side of the alignment film opposite to the light absorption anisotropic layer is further improved, the above-described polymerizable polymer preferably has a repeating unit represented by Formula (1).

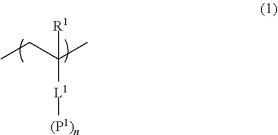

R¹ represents a hydrogen atom or an alkyl group having 1 to 4 carbon atoms.

L¹ represents a single bond or an (n+1)-valent linking group. For example, in a case where n is 1, L¹ represents a divalent linking group, and in a case where n is 2, L¹ represents a trivalent linking group. In a case where L¹ is a single bond, n represents 0.

Examples of the divalent linking group include a divalent aliphatic hydrocarbon group (for example, an alkylene group) which may have a substituent, an arylene group which may have a substituent, a heteroarylene which may have a substituent, —O—, —CO—, —NH—, and a group obtained by combining two or more of these groups. Examples of the group obtained by combining two or more of the above-described groups include —CO—O-divalent aliphatic hydrocarbon group which may have a substituent and —O—; —CO—O-divalent aliphatic hydrocarbon group which may have a substituent and —NH—; and —CO—O-divalent aliphatic hydrocarbon group which may have a substituent and —O—CO—NH-divalent aliphatic hydrocarbon group which may have a substituent.

Examples of the trivalent linking group include a trivalent aliphatic hydrocarbon group which may have a substituent, a trivalent aromatic group which may have a substituent, a nitrogen atom (>N—), and a group obtained by combining these groups with the above-described divalent linking group.

P¹ represents a polymerizable group. Examples of the polymerizable group include the above-described polymerizable group capable of radical polymerization or cationic polymerization.

n represents an integer of 1 or more. Among these, from the reason that the peelability of the above-described alignment film with any member (for example, a base material) provided on a side of the alignment film opposite to the light absorption anisotropic layer is further improved, n is preferably 1 or 2 and more preferably 1.

A content of the repeating unit represented by Formula (1) is preferably 20% by mass or more, more preferably 30% by mass or more, and still more preferably 50% by mass or more with respect to the total mass of all repeating units of the polymerizable polymer. The upper limit thereof is not particularly limited, and examples thereof include 100% by mass, usually 95% by mass or less.

Examples of the repeating unit represented by Formula (1) include repeating units shown in Table 1, and these may be used alone or in combination of two or more kinds thereof

TABLE 1

| No. | Structure |
|---|---|
| A1 | 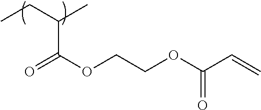 |
| A2 | 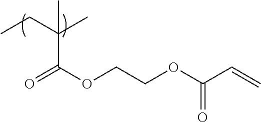 |
| A3 | 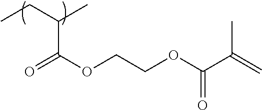 |
| A4 | 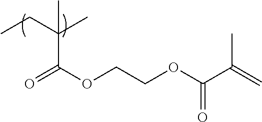 |
| A5 | 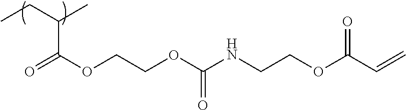 |
| A6 | 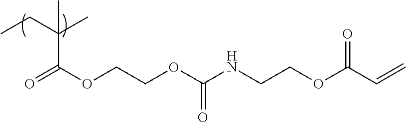 |
| A7 | 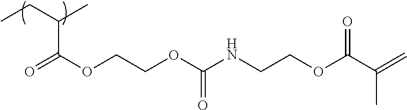 |
| A8 | 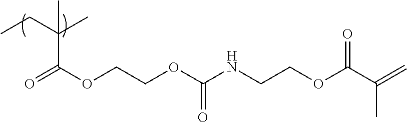 |
| A9 | 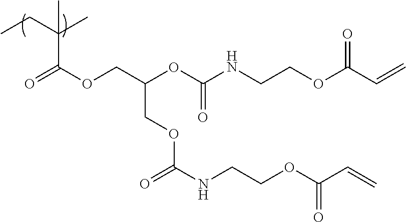 |
| A10 | 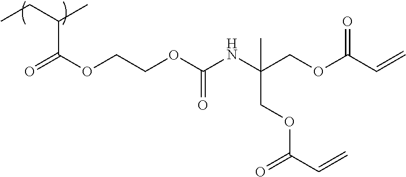 |
| A11 | 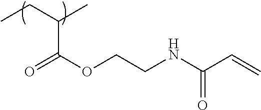 |
| A12 | 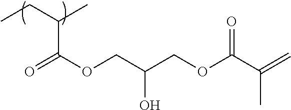 |
| A13 | 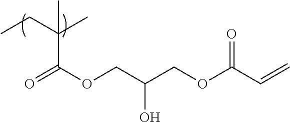 |
| A14 | 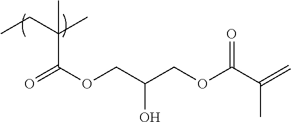 |
| A15 | 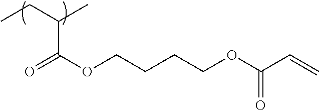 |
| A16 | 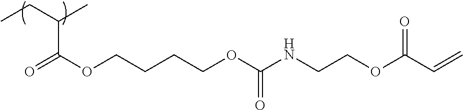 |
| A17 | 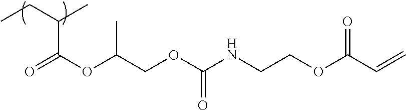 |
| A18 | 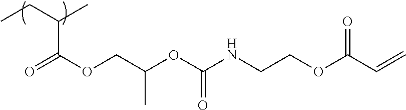 |
| A19 | 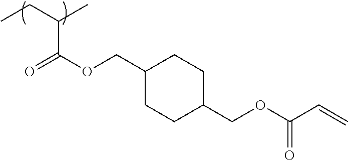 |
| A20 | 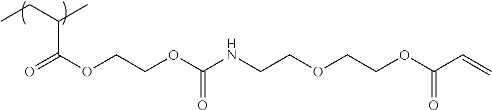 |

The polymerizable polymer may have a repeating unit in addition to the repeating unit represented by Formula (1).

From the reason that the peelability of the above-described alignment film with any member (for example, a base material) provided on a side of the alignment film opposite to the light absorption anisotropic layer is further improved, examples of other repeating units include a repeating unit represented by Formula (2).

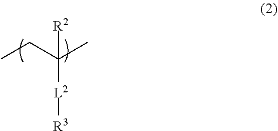

R² represents a hydrogen atom or an alkyl group having 1 to 4 carbon atoms.

L² represents a single bond or a divalent linking group. Examples of the divalent linking group include the groups exemplified as the divalent linking group represented by L¹ described above.

R³ represents an aliphatic hydrocarbon group which may have a substituent or a group in which one or more of —CH₂—'s constituting the aliphatic hydrocarbon group are substituted with —O—, —S—, —NH—, —N(Q)-, or —CO—. Q represents a substituent.

The number of carbon atoms in the above-described aliphatic hydrocarbon group is not particularly limited, but is preferably 1 to 20 and more preferably 1 to 10.

The aliphatic hydrocarbon group may be linear or branched. In addition, the aliphatic hydrocarbon group may have a cyclic structure.

The substituent is not particularly limited, and examples thereof include an alkyl group, an alkoxy group, an alkyl-substituted alkoxy group, a cyclic alkyl group, an aryl group (for example, a phenyl group and a naphthyl group), a cyano group, an amino group, a nitro group, an alkylcarbonyl group, a sulfo group, and a hydroxyl group.

In a case where the polymerizable polymer contains other repeating units, a content of the other repeating units (for example, the repeating unit represented by Formula (2)) is not particularly limited, but is preferably 80% by mass or less, more preferably 50% by mass or less, and still more preferably 30% by mass or less with respect to the total mass of all repeating units of the polymerizable polymer. The lower limit thereof is not particularly limited, but may be 5% by mass or more.

Examples of the other repeating units include repeating units shown in Table 2, and these may be used alone or in combination of two or more kinds thereof.

TABLE 2

| No. | Structure |
|---|---|
| B1 | 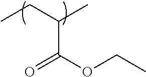 |
| B2 | 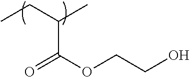 |
| B3 | 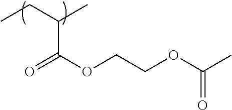 |
| B4 | 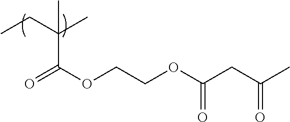 |
| B5 | 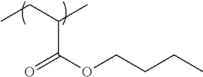 |
| B6 | 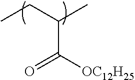 |

In the present invention, from the viewpoint of further improving the peelability of the above-described alignment film with any member (for example, a base material) provided on a side of the alignment film opposite to the light absorption anisotropic layer and ensuring solubility in a coating liquid, a weight-average molecular weight of the above-described polymer compound is preferably 5,000 to 100,000 and more preferably 7,500 to 50,000.

Here, the weight-average molecular weight is a value measured by a gel permeation chromatography (GPC) method under the following conditions.
Solvent (eluant): Tetrahydrofuran (THF)
Device Name: TOSOH HLC-8320GPC
Column: Three items of TOSOH TSKgel Super HZM-H (4.6 mm×15 cm) are connected and used.
Column Temperature: 40° C.
Sample Concentration: 0.1 mass %
Flow Rate: 1.0 ml/min
Calibration curve: TSK standard polystyrene (manufactured by TOSOH Corporation), calibration curves of 7 samples with Mw of 2,800,000 to 1,050 (Mw/Mn=1.03 to 1.06) are used

In the present invention, from the reason that the peelability of the above-described alignment film with any member (for example, a base material) provided on a side of the alignment film opposite to the light absorption anisotropic layer is further improved, it is preferable that the above-described polymer compound is the polymer of the above-described polymerizable polymer, that is, a crosslinked substance of the above-described polymerizable polymer among the above-described specific compounds.

In the present invention, from the viewpoint of increasing an alignment degree of the light absorption anisotropic layer described later, a content of the above-described polymer compound is preferably 0.2% to 20% by mass, more preferably 0.3% to 10% by mass, and still more preferably 0.4% to 8% by mass with respect to the mass of the above-described alignment film.

### <Surfactant>

In the present invention, from the viewpoint of further improving the display performance of the virtual reality display apparatus in a case where the laminate according to the embodiment of the present invention is introduced into the virtual reality display apparatus, it is preferable that the above-described alignment film (particularly, the photo-alignment film) contains a surfactant.

In a case of containing a surfactant, smoothness of a coated surface is improved, the alignment degree is further improved, and cissing and unevenness are suppressed so that in-plane uniformity is expected to be improved.

In particular, from the viewpoint of suppressing the cissing in a case of forming the light absorption anisotropic layer on the alignment film, a polymer having a repeating unit B described in paragraphs [0037] to [0053] of WO2022/024683A (hereinafter, referred to as “acid-cleavable surfactant”) can be suitably used as the surfactant.

A thickness of the above-described alignment film is not particularly limited, but is preferably 0.1 to 10 μm and more preferably 0.5 to 5 μm.

### [Light Absorption Anisotropic Layer]

The light absorption anisotropic layer included in the laminate according to the embodiment of the present invention is a light absorption anisotropic layer containing a liquid crystal compound and a dichroic substance, which is provided on the above-described alignment film, and is preferably a layer in which alignment states of the liquid crystal compound and the dichroic substance are fixed.

Hereinafter, the liquid crystal compound, the dichroic substance, and any components contained in the light absorption anisotropic layer will be described.

### <Liquid Crystal Compound>

As the liquid crystal compound, any of a high-molecular-weight liquid crystal compound or a low-molecular-weight liquid crystal compound can be used.

Here, the “high-molecular-weight liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the high-molecular-weight liquid crystal compound include thermotropic liquid crystalline polymers described in JP2011-237513A and high-molecular-weight liquid crystal compounds described in paragraphs [0012] to [0042] of WO2018/199096A.

Examples of the low-molecular-weight liquid crystal compound include liquid crystal compounds described in paragraphs [0072] to [0088] of JP2013-228706A, and among these, a liquid crystal compound exhibiting smectic properties is preferable.

Examples of such a liquid crystal compound include compounds described in paragraphs [0019] to [0140] of WO2022/014340A, the description of which is incorporated herein by reference.

A content of the liquid crystal compound is preferably 50% to 99% by mass and more preferably 75% to 90% by mass with respect to the total mass of the light absorption anisotropic layer.

### <Dichroic Substance>

In the present invention, the dichroic substance means a coloring agent having different absorbances depending on directions. The dichroic substance may or may not exhibit liquid crystallinity.

The dichroic substance is not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). In addition, known dichroic substances (dichroic coloring agents) of the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

In the present invention, as the dichroic substance, from the viewpoint of enhancing dichroism, a dichroic azo coloring agent compound is preferably used, and a dichroic azo coloring agent compound having a thienothiazole skeleton is more preferably used.

The dichroic azo coloring agent compound denotes an azo coloring agent compound having different absorbances depending on the direction. The dichroic azo coloring agent compound may or may not exhibit liquid crystallinity. In a case where the dichroic azo coloring agent compound exhibits liquid crystallinity, any of nematic properties or smectic properties may be exhibited. A temperature range at which the liquid crystal phase is exhibited is preferably room temperature (approximately 20° C. to 28° C.) to 300° C., and from the viewpoint of handleability and manufacturing suitability, more preferably 50° C. to 200° C.

In the present invention, from the viewpoint of tint adjustment, it is preferable to use at least one coloring agent compound (first dichroic azo coloring agent compound) having a maximal absorption wavelength in a wavelength range of 560 to 700 nm and at least one coloring agent compound (second dichroic azo coloring agent compound) having a maximal absorption wavelength in a wavelength range of 455 nm or more and less than 560 nm.

In the present invention, three or more kinds of dichroic azo coloring agent compounds may be used in combination. For example, from the viewpoint of making color of the light absorption anisotropic layer close to black, it is preferable to use the first dichroic azo coloring agent compound, the second dichroic azo coloring agent compound, and at least one coloring agent compound having a maximal absorption wavelength in a wavelength range of 380 nm or more and less than 455 nm (third dichroic azo coloring agent compound) in combination.

In the present invention, it is preferable that the dichroic azo coloring agent compound has a crosslinkable group.

Examples of the crosslinkable group include a (meth)acryloyl group, an epoxy group, an oxetanyl group, and a styryl group, and among these, a (meth)acryloyl group is preferable.

A content of the dichroic substance is not particularly limited, but from the viewpoint of increasing the alignment degree of the light absorption anisotropic layer to be formed, it is preferably 3% by mass or more, more preferably 8% by mass or more, and still more preferably 10% by mass or more with respect to the total mass of the light absorption anisotropic layer. The upper limit value of the content of the dichroic substance is not particularly limited, but is preferably 30% by mass or less, more preferably 29% by mass or less, and still more preferably 25% by mass or less with respect to the total mass of the light absorption anisotropic layer. In a case where a plurality of dichroic substances are used in combination, it is preferable that the total amount of the plurality of dichroic substances is within the above-described range.

In addition, from the viewpoint of increasing the alignment degree of the light absorption anisotropic layer to be formed, the content of the dichroic substance is preferably 10 to 400 mg/cm³, more preferably 30 to 300 mg/cm³, and still more preferably 40 to 250 mg/cm³. In a case where a plurality of dichroic substances are used in combination, it is preferable that the total amount of the plurality of dichroic substances is within the above-described range.

Here, the content (mg/cm³) of the dichroic substance is obtained by measuring a solution in which an optical laminate including the light absorption anisotropic layer is dissolved, or an extraction liquid obtained by immersing the optical laminate in a solvent, using high performance liquid chromatography (HPLC); but the measurement method is not limited to the above-described method. In addition, the quantification can be performed by using the dichroic substance contained in the light absorption anisotropic layer as a standard sample.

Examples of the method of calculating the content of the dichroic substance include a method in which the volume is calculated by multiplying the thickness of the light absorption anisotropic layer obtained from a microscopic observation image of a cross section of the optical laminate by the area of the optical laminate used for measuring the coloring agent amount, and is divided by the coloring agent amount measured by HPLC to calculate the content of the coloring agent.

A thickness of the above-described light absorption anisotropic layer is not particularly limited, but is preferably 0.1 to 10 μm and more preferably 0.5 to 5 μm.

### <Manufacturing Method of Light Absorption Anisotropic Layer>

A manufacturing method of the light absorption anisotropic layer is not particularly limited, but from the viewpoint of further increasing the alignment degree of the dichroic substance, a method (hereinafter, also referred to as “present manufacturing method”) including, in the following order, a step of applying a composition for forming a light absorption anisotropic layer, which contains a liquid crystal compound and a dichroic substance, onto the above-described alignment film to form a coating film (hereinafter, also referred to as “coating film-forming step”) and a step of aligning a liquid crystal component contained in the coating film (hereinafter, also referred to as “alignment step”) is preferable.

The liquid crystal component is a component which includes not only the above-described liquid crystal compound but also a dichroic substance having liquid crystallinity.

Hereinafter, the respective steps will be described.

The coating film-forming step is a step of applying the above-described composition for forming a light absorption anisotropic layer onto the alignment film to form a coating film.

The composition for forming a light absorption anisotropic layer can be easily applied onto the alignment film by using a composition for forming a light absorption anisotropic layer, which contains the above-described solvent, or using a liquid such as a melt obtained by heating the composition for forming a light absorption anisotropic layer.

Examples of a method of applying the composition for forming a light absorption anisotropic layer include known methods such as a roll coating method, a gravure printing method, a spin coating method, a wire bar coating method, an extrusion coating method, a direct gravure coating method, a reverse gravure coating method, a die coating method, a spraying method, and an ink jet method.

The alignment step is a step of aligning a liquid crystal component (particularly, the dichroic substance) contained in the coating film. In the alignment step, the dichroic substance is considered to be aligned along the liquid crystal compound aligned by the alignment film.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

It is preferable that the alignment step includes a heat treatment. As a result, the dichroic substance contained in the coating film is further aligned, and the alignment degree of the dichroic substance is further increased.

From the viewpoint of manufacturing suitability, the heat treatment is performed at a temperature of preferably 10° C. to 250° C. and more preferably 25° C. to 190° C. In addition, the heating time is preferably 1 to 300 seconds and more preferably 1 to 60 seconds.

The alignment step may include a cooling treatment performed after the heat treatment. The cooling treatment is a treatment of cooling the heated coating film to room temperature (20° C. to 25° C.). As a result, the alignment of the dichroic substance contained in the coating film is further fixed, and the alignment degree of the dichroic substance is further increased. A cooling unit is not particularly limited, and the cooling treatment can be performed according to a known method.

The light absorption anisotropic layer can be obtained by performing the above-described steps.

The present manufacturing method may include a step of curing the light absorption anisotropic layer after the above-described alignment step (hereinafter, also referred to as “curing step”).

The curing step is performed by, for example, heating the film and/or irradiating (exposing) the optically functional film with light. Among these, it is preferable that the curing step is performed by irradiating the light absorption anisotropic film with light.

Various light sources such as infrared rays, visible light, and ultraviolet rays can be used as a light source for curing, but ultraviolet rays are preferable. In addition, ultraviolet rays may be applied while the layer is heated during curing, or ultraviolet rays may be applied through a filter which transmits only a specific wavelength.

In addition, the exposure may be performed under a nitrogen atmosphere. In a case where the curing of the light absorption anisotropic layer proceeds by radical polymerization, since inhibition of polymerization by oxygen is reduced, it is preferable that the exposure is performed in a nitrogen atmosphere.

### [Protective Layer]

From the viewpoint of improving durability, the laminate according to the embodiment of the present invention preferably includes a protective layer having an oxygen permeability coefficient of 200 cc/m²·day·atm or less on a side of the light absorption anisotropic layer opposite to the alignment film, and more preferably includes a protective layer having an oxygen permeability coefficient of 50 cc/m²·day·atm or less.

In addition, in a case where there is a layer other than the protective layer, which has the same properties as the protective layer, the protective layer does not need to be provided.

Here, the oxygen permeability coefficient is an index indicating an amount of oxygen passing through the film per unit time and unit area, and in the present invention, a value measured by an oxygen concentration device (for example, MODEL3600 manufactured by Hack Ultra Analytical) in an environment of 25° C. and a relative humidity (RH) of 50% is employed.

Specific examples of the protective layer include films containing an organic compound such as a polyvinyl alcohol-based resin, a polyethylene vinyl alcohol-based resin, polyvinyl ether, polyvinylpyrrolidone, polyacrylamide, polyacrylic acid, cellulose ether, polyamide, polyimide, a styrene-maleic acid copolymer, gelatin, vinylidene chloride, and cellulose nanofiber.

Among these, from the viewpoint of high oxygen shielding ability, a polyvinyl alcohol-based resin film or a polyethylene vinyl alcohol-based resin film is preferable, and a polyvinyl alcohol-based resin film is more preferable.

From the viewpoint of high oxygen shielding ability, examples of the organic compound contained in the protective layer include a polymerizable compound having a high hydrogen bonding property and a compound having a large number of polymerizable groups per molecular weight. Examples of the compound having a large number of polymerizable groups per molecular weight include pentaerythritol tetra(meth)acrylate and dipentaerythritol hexa(meth)acrylate.

Examples of the polymerizable compound having a high hydrogen bonding property include an epoxy compound, and specific examples thereof include compounds represented by the following formulae. Among these, 3′,4′-epoxycyclohexylmethyl-3,4-epoxycyclohexanecarboxylate represented by CEL2021P is preferable.

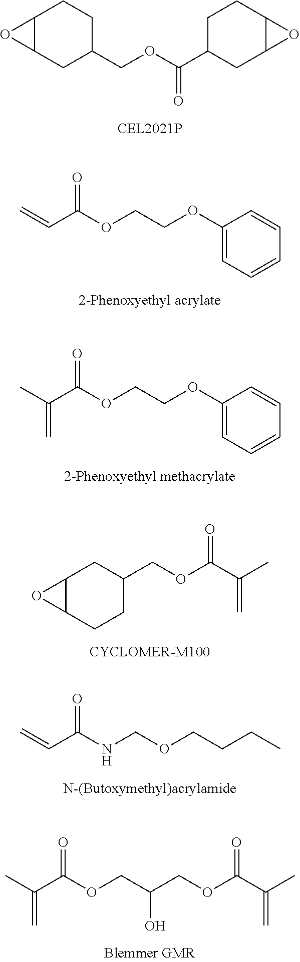

From the viewpoint of preventing the dichroic coloring agent of the light absorption anisotropic layer from diffusing during durability, it is also preferable to use, as the protective layer, a polymer having a hydrophilic group, described in paragraph [0056] of WO2019-22121A, or a water-soluble polymer described in paragraphs [0117] to [0133] of JP2017-083483A.

### [Pressure-Sensitive Adhesive Layer]

The laminate according to the embodiment of the present invention may or may not include a pressure-sensitive adhesive layer.

Examples of a pressure-sensitive adhesive constituting the pressure-sensitive adhesive layer include a pressure sensitive adhesive and an adhesive.

Examples of the pressure sensitive adhesive include a rubber-based pressure sensitive adhesive, an acrylic pressure sensitive adhesive, a silicone-based pressure sensitive adhesive, an urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive; and among these, an acrylic pressure sensitive adhesive (pressure-sensitive adhesive) is preferable.

Examples of the adhesive include a water-based adhesive, a solvent-based adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet-curable adhesive, and a visible light-curable adhesive; and among these, an ultraviolet-curable adhesive is preferable.

A thickness of the pressure-sensitive adhesive layer is not particularly limited, but from the viewpoint of thinning, it is preferably 25 μm or less, more preferably 15 μm or less, and still more preferably 5 μm or less. The lower limit thereof is not particularly limited, but is 0.1 μm or more in many cases.

From the viewpoint of simplifying the configuration of the laminate and thinning the laminate, it is also preferable to impart a function of improving the durability of the protective layer to the pressure-sensitive adhesive layer to have a configuration in which the light absorption anisotropic layer and the pressure-sensitive adhesive layer are adjacent to each other without providing the protective layer. For example, a configuration in which the alignment layer, the light absorption anisotropic layer, the pressure-sensitive adhesive layer, and a retardation layer are arranged adjacent to each other in this order can be mentioned.

In addition, the pressure-sensitive adhesive layer may impart a function of preventing the dichroic coloring agent in the light absorption anisotropic layer from diffusing during durability. In order to exhibit the above-described diffusion prevention function, for example, an oxygen permeability coefficient of the pressure-sensitive adhesive layer is preferably 200 cc/m²·day·atm or less, and more preferably 50 cc/m²·day·atm or less.

Examples of the pressure-sensitive adhesive layer having the above-described diffusion prevention function include an adhesive containing polyvinyl alcohol as a main component, an UV adhesive having low oxygen permeability, and a pressure sensitive adhesive containing a hydrophilic group-containing polymer.

### [Manufacturing Method of Laminate]

The manufacturing method of the laminate according to the embodiment of the present invention is a manufacturing method of a laminate, including an alignment film-forming step of forming an alignment film on a base material using a composition for forming an alignment film; a light absorption anisotropic layer-forming step of, after the alignment film-forming step, forming a light absorption anisotropic layer on the alignment film using a composition for forming a light absorption anisotropic layer, which contains a liquid crystal compound and a dichroic substance; and a base material peeling step of, after the light absorption anisotropic layer-forming step, peeling off the base material to manufacture a laminate of the alignment film and the light absorption anisotropic layer.

Hereinafter, each step of the manufacturing method of a laminate according to the embodiment of the present invention will be described.

### [Alignment Film-Forming Step]

### <Base Material>

The base material used in the alignment film-forming step is not particularly limited, and a known base material can be used. In particular, it is preferable to use a transparent base material. The transparent base material is intended to be a base material in which the transmittance of visible light is 60% or more, preferably 80% or more and more preferably 90% or more.

Examples of the above-described base material include a glass substrate and a polymer film.

Examples of a material of the polymer film include cellulose-based polymers; acrylic polymers having an acrylic acid ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer; polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers.

In addition, the above-described base material may be a peelable base material (temporary support).

Among these, a polymer film (cellulose acylate-based film) formed of a cellulose-based polymer, particularly a cellulose acylate-based polymer is preferable.

A thickness of the above-described base material is not particularly limited, but is preferably 10 to 100 μm and more preferably 30 to 80 μm.

### <Composition for Forming Alignment Film>

The composition for forming an alignment film is not particularly limited, and examples thereof include, in a case of forming the photo-alignment film which is the suitable aspect of the alignment film, a composition containing the photo-alignment compound (particularly, the photosensitive compound having the photo-aligned group), the polymerization initiator, and the solvent as described above.

In the present invention, from the viewpoint of easily peeling off the base material in the base material peeling step described later, it is preferable that the composition for forming an alignment film contains the above-described polymer compound, and an absolute value of a difference between an SP value of the above-described polymer compound and an SP value of the above-described base material is 1.7 MPa^{1/2} or less. The lower limit thereof is not particularly limited, but may be, for example, 0.

Here, the SP value is intended to be a non-dispersive force component δa of an SP value calculated by the method of Hoy et al. (see “PROPERTIES OF POLYMERS (ED. 3)”, written by VAN KREVELEN, D. W., Elsevier Publishing (1990)).

That is, the δa value can be calculated by the following expression (X) using a three-dimensional SP value (δd, δp, and δh) calculated by the method of Hoy et al.

$$δ a = {( δ {p}^{2} + δ {h}^{2} )}^{0.5} \qquad Expression ( X )$$

According to the method of Hoy et al., the values of δd, δp, and δh can be calculated from a chemical structural formula of the compound to be obtained.

In a case of a copolymer consisting of a plurality of repeating units, the three-dimensional SP value of the copolymer can be calculated by obtaining the sum of the values obtained by multiplying a volume fraction of each repeating unit by the square of the three-dimensional SP value of each repeating unit (δd², δp², and δh²), and substituting the values into the expression (X) to obtain the δa value of the copolymer.

In addition, in the present invention, from the viewpoint of easily adjusting the film thickness variation of the formed alignment film to 10% or less, a viscosity of the composition for forming an alignment film at 25° C. is preferably 2 mPa·s or more and less than 10 mPa·s, and more preferably 2 mPa·s or more and 5 mPa·s or less.

Here, the viscosity of the composition for forming an alignment film at 25° C. can be measured using a cone-plate type rotational viscometer in accordance with JIS Z 8803 (2011).

Furthermore, in the present invention, from the viewpoint of more easily adjusting the film thickness variation of the formed alignment film to 10% or less, it is preferable that the alignment film-forming step includes a drying treatment of drying a coating film obtained by applying the composition for forming an alignment film onto the base material, the coating film having a concentration of solid contents of 60% or less, with wind having a wind speed of 2 m/s or less.

Here, the above-described wind speed in the drying treatment is preferably 2.0 m or less and more preferably 1.0 m or less.

In addition, the above-described drying treatment may be performed not only on the coating film having a solid content of 60% by mass or less, but also on a coating film having a solid content of more than 60% by mass, that is, a coating film immediately after the composition for forming an alignment film is applied onto the base material.

In the present invention, the method of forming the alignment film using the composition for forming an alignment film is not particularly limited in conditions other than the viscosity of the composition for forming an alignment film and the drying treatment described above, and a known method in the related art can be adopted.

Specifically, in a case of forming the photo-alignment film which is the suitable aspect of the alignment film, for example, the photo-alignment film can be manufactured by a coating step of coating the above-described base material with the composition for forming an alignment film to form a first coating film; a drying step of heating the first coating film to dry and remove the organic solvent, thereby forming a first dried coating film on the above-described base material; and a light irradiation step of irradiating the first dried coating film with polarized ultraviolet rays (UV) or with non-polarized UV rays from an oblique direction with respect to a surface of the coating film to form the photo-alignment film from the first dried coating film.

### <Coating Step>

A coating method in the coating step is not particularly limited and can be appropriately selected depending on the purposes, and examples of the method include spin coating, die coating, gravure coating, flexography, and ink jet printing.

### <Drying Step>

A temperature of the drying step is not particularly limited as long as the organic solvent contained in the first coating film can be dried and removed, but in a case where the composition for forming an alignment film contains the polymerization initiator, from the viewpoint of allowing a polymerization reaction, the temperature is preferably 120° C. to 160° C. and more preferably 130° C. to 150° C.

In addition, a time of the drying step is not particularly limited as long as the organic solvent contained in the first coating film can be dried and removed, but in a case where the composition for forming an alignment film contains the polymerization initiator, from the viewpoint of allowing a polymerization reaction to proceed sufficiently, the time is preferably 30 seconds to 5 minutes and more preferably 1 minute to 3 minutes.

### <Light Irradiation Step>

In the light irradiation step, the polarized light to be applied to the first dried coating film is not particularly limited, and examples thereof include linearly polarized light, circularly polarized light, and elliptically polarized light. Among these, linearly polarized light is preferable.

In addition, the “oblique direction” for the irradiation with the non-polarized light is not particularly limited as long as it is a direction tilted by a polar angle θ (0<0<90°) with respect to a normal direction of the surface of the coating film, and can be suitably selected according to the purpose; and θ is preferably 20° to 80°.

A wavelength of the polarized light or the non-polarized light is not particularly limited as long as the first dried coating film can impart alignment controllability to the liquid crystalline molecules, and examples thereof include ultraviolet rays, near-ultraviolet rays, and visible rays. Among those, near-ultraviolet rays at 250 nm to 450 nm are particularly preferable.

In addition, examples of a light source for the irradiation with the polarized light or the non-polarized light include a xenon lamp, a high-pressure mercury lamp, an ultra-high pressure mercury lamp, and a metal halide lamp. The wavelength range of the irradiation can be controlled by using an interference filter, a color filter, or the like for ultraviolet rays or visible rays, obtained from such a light source. In addition, the linearly polarized light can be obtained using a polarization filter or a polarization prism with respect to the light from the light source.

An integrated light amount of the polarized light or the non-polarized light is not particularly limited as long as the first dried coating film can impart alignment controllability to the liquid crystalline molecules, and it is preferably 1 to 300 mJ/cm² and more preferably 5 to 100 mJ/cm².

An illuminance of the polarized light or the non-polarized light is not particularly limited as long as the first dried coating film can impart alignment controllability to the liquid crystalline molecules, and it is preferably 0.1 to 300 mW/cm² and more preferably 1 to 100 mW/cm².

### [Virtual Reality Display Apparatus]

As one example (first aspect) of the virtual reality display apparatus according to the embodiment of the present invention, a virtual reality display apparatus including, in the following order, an image display panel, a first absorption type linear polarizer, a first retardation layer, a reflective type circular polarizer, a half mirror, a second retardation layer, and a second absorption type linear polarizer is exemplified.

In addition, as another example (second aspect), a virtual reality display apparatus including, in the following order, an image display panel, a first absorption type linear polarizer, a first retardation layer, a second retardation layer, a reflective type linear polarizer, a third retardation layer, a half mirror, and a second absorption type linear polarizer is exemplified.

In addition, as another example (third aspect), a virtual reality display apparatus including, in the following order, an image display panel, a first absorption type linear polarizer, a first retardation layer, a half mirror, a reflective type circular polarizer, a second retardation layer, and a second absorption type linear polarizer is exemplified.

In addition, as another example (fourth aspect), a virtual reality display apparatus including, in the following order, an image display panel, a first absorption type linear polarizer, a first retardation layer, a half mirror, a second retardation layer, a reflective type linear polarizer, and a second absorption type linear polarizer is exemplified.

In addition, in the virtual reality display apparatus according to the embodiment of the present invention, the second absorption type linear polarizer is the above-described laminate according to the embodiment of the present invention.

In addition, it is preferable that the virtual reality display apparatus according to the embodiment of the present invention includes a third retardation layer between the image display panel and the first absorption type linear polarizer.

In addition, it is also preferable that the virtual reality display apparatus according to the embodiment of the present invention includes a fourth retardation layer on a viewing side of the second absorption type linear polarizer.

FIG. 2 shows a schematic cross-sectional view showing an example of the virtual reality display apparatus according to the embodiment of the present invention.

A virtual reality display apparatus 100 shown in FIG. 2 is a virtual reality display apparatus including, in the following order, an image display panel 70, a first absorption type linear polarizer 21, a first retardation layer 11, a reflective type circular polarizer 30, a half mirror 40, a second retardation layer 12, and a second absorption type linear polarizer 22.

In addition, the virtual reality display apparatus 100 shown in FIG. 2 includes a third retardation layer 13 between the image display panel 70 and the first absorption type linear polarizer 21.

In addition, the virtual reality display apparatus 100 shown in FIG. 2 includes an antireflection layer 50 and a positive C-plate 60.

### [Image Display Panel]

As the image display panel, a known image display panel can be used. Examples thereof include a display panel in which self-luminous microscopic light emitters are arranged on a transparent substrate, such as an organic electroluminescent display panel, a light emitting diode (LED) display panel, and a micro LED display panel; and a liquid crystal display panel.

In the following description, the organic electroluminescent display device will also be referred to as “OLED”. OLED is an abbreviation for “Organic Light Emitting Diode”.

### [First to Third Retardation Layers]

The retardation layer has a function of converting emitted light into substantially linearly polarized light in a case where circularly polarized light is incident. For example, a λ/4 retardation layer in which Re is approximately ¼ wavelength at any of wavelengths in the visible range can be used, and an in-plane retardation Re (550) at a wavelength of 550 nm is preferably 120 nm to 150 nm, more preferably 125 nm to 145 nm, and still more preferably 135 nm to 140 nm.

In addition, a retardation layer in which the Re is an approximately ¾ wavelength or approximately 5/4 wavelength is also preferable from the viewpoint that the linearly polarized light can be converted into the circularly polarized light.

In addition, it is preferable that the retardation layer has reverse dispersibility with respect to the wavelength. It is preferable that the retardation layer has reverse dispersibility from the viewpoint that circularly polarized light can be converted into linearly polarized light over a wide wavelength range in the visible region. Here, the expression “having reverse dispersibility with respect to the wavelength” denotes that as the wavelength increases, the value of the retardation at the wavelength increases.

The retardation layer having reverse dispersibility can be prepared, for example, by uniaxially stretching a polymer film such as a modified polycarbonate resin film having reverse dispersibility with reference to JP2017-049574A and the like.

In addition, the retardation layer having reverse dispersibility is not limited as long as the retardation layer substantially has reverse dispersibility, and can be prepared by laminating a retardation layer having Re of an approximately ¼ wavelength and a retardation layer having Re of an approximately ½ wavelength such that the slow axes form an angle of approximately 600 as described in, for example, JP6259925B. Here, it is known that even in a case where the ¼ wavelength retardation layer and the ½ wavelength retardation layer each have forward dispersibility (as the wavelength increases, the value of the phase difference at the wavelength decreases), circularly polarized light can be converted into linearly polarized light over a wide wavelength range in the visible region, and the layers can be regarded as having substantially reverse dispersibility.

In addition, it is also preferable that the retardation layer has a layer formed by immobilizing uniformly aligned liquid crystal compounds. For example, a layer formed by uniformly aligning rod-like liquid crystal compounds horizontally to the in-plane direction or a layer formed by uniformly aligning disk-like liquid crystal compounds vertically to the in-plane direction can be used. Furthermore, for example, a retardation layer having reverse dispersibility can be prepared by uniformly aligning rod-like liquid crystal compounds having reverse dispersibility and immobilizing the compounds with reference to JP2020-084070A and the like.

In addition, it is also preferable that the retardation layer body has a layer formed by immobilizing twistedly aligned liquid crystal compounds with a helical axis in the thickness direction. For example, as described in JP5753922B and JP5960743B, it is preferable that a retardation layer having a layer formed by immobilizing twistedly aligned rod-like liquid crystal compounds or twistedly aligned disk-like liquid crystal compounds with a helical axis in the thickness direction is used from the viewpoint that the retardation layer can be regarded as having substantially reverse dispersibility.

A thickness of the retardation layer is not particularly limited, but is preferably 0.1 to 8 m and more preferably 0.3 to 5 μm from the viewpoint of thinning.

### [Positive C-Plate]

As the positive C-plate, a positive C-plate having a thickness direction retardation (Rth (550)) of −150 to −50 nm at a wavelength of 550 nm is preferable. By including such a positive C-plate, it is possible to further suppress light leakage and tinting in a perspective direction of the display device.

The thickness direction retardation (Rth (550)) of the positive C-plate at a wavelength of 550 nm is −150 to −50 nm, preferably −130 to −60 nm and more preferably −120 to −70 nm.

A thickness of the positive C-plate is not particularly limited, but from the viewpoint of thinning, it is preferably 0.5 to 10 μm and more preferably 0.5 to 5 μm. In addition, in a case of providing the positive C-plate, the positive C-plate may be provided alone by transfer, coating, or the like, but other functional layers may be provided together with the positive C-plate as necessary. Such a functional layer may be a protective film, a hard coat layer, or a cushion layer. As the protective film, each of the films described as the protective film of the polarizer above can be used.

A material constituting the positive C-plate is not particularly limited, but it is preferable that the positive C-plate is formed of a composition containing a liquid crystal compound. It is preferable to form the positive C-plate from a polymerizable liquid crystal composition containing a polymerizable liquid crystal compound, from the viewpoint of improvement of temporal durability and alignment order. Such a positive C-plate can be typically obtained by vertically aligning a rod-like polymerizable liquid crystal compound contained in the polymerizable liquid crystal composition and fixing the alignment state by polymerization. In addition, the positive C-plate can also be formed of a composition containing a side chain-type polymer liquid crystal compound as the liquid crystal compound.

### [Absorption Type Linear Polarizer]

The absorption type linear polarizer is an absorption type polarizer, and absorbs linearly polarized light in an absorption axis direction among incidence rays and transmits linearly polarized light in a transmission axis direction. A typical polarizer can be used as the absorption type linear polarizer, and preferred examples thereof include a polarizer in which a dichroic substance is dyed on polyvinyl alcohol or another polymer resin and is stretched so that the dichroic substance is aligned and a polarizer in which a dichroic substance is aligned by using alignment of a liquid crystal compound. Among these, from the viewpoint of availability and an increase in degree of polarization, a polarizer obtained by dyeing polyvinyl alcohol with iodine and stretching polyvinyl alcohol is preferable.

In the present invention, the above-described laminate according to the embodiment of the present invention is used as the second absorption type linear polarizer.

A thickness of the absorption type linear polarizer is preferably 10 μm or less, more preferably 7 μm or less, and still more preferably 5 μm or less. In a case where the absorption type linear polarizer is thin, cracks or breakage of the film can be prevented in a case where the laminated optical film is stretched or molded.

In addition, a single plate transmittance of the absorption type linear polarizer is preferably 40% or more, and more preferably 42% or more. Moreover, a degree of polarization is preferably 90% or more, more preferably 95% or more, and still more preferably 99% or more. In the present invention, the single plate transmittance and the degree of polarization of the absorption type linear polarizer are measured using an automatic polarizing film measuring device: VAP-7070 (manufactured by Jasco Corporation).

In addition, it is preferable that the direction of the transmission axis of the absorption type linear polarizer coincides with the direction of the polarization axis of light converted into linearly polarized light by the retardation layer. For example, in a case where an absorptive type retardation layer has a λ/4 retardation layer, an angle between the transmission axis of the absorption type linear polarizer and the slow axis of the λ/4 retardation layer is preferably approximately 45°.

### [Half Mirror]

The half mirror is a known half mirror in the related art, which allows transmission of about half of incident light and reflects the remaining half of the incident light. The transmittance of the half mirror is preferably 50±30%, more preferably 50±10%, and most preferably 50%.

Examples of the half mirror include a configuration in which a reflective layer consisting of a metal such as silver and aluminum is provided on a base material consisting of a transparent resin such as polyethylene terephthalate (PET), a cycloolefin polymer (COP), and polymethyl methacrylate (PMMA), or on glass. The reflective layer consisting of a metal such as silver and aluminum can be formed on the surface of the base material by vapor deposition or the like.

A thickness of the reflective layer is preferably 1 to 20 nm, more preferably 2 to 10 nm, and still more preferably 3 to 6 nm.

In addition, it is preferable that the base material does not have a retardation. From this viewpoint, the base material of the half mirror is preferably a cycloolefin polymer (COP), polymethyl methacrylate (PMMA), or glass.

### [Reflective Type Circular Polarizer]

The reflective type circular polarizer is a polarizer which allows transmission of dextrorotatory circularly polarized light or levorotatory circularly polarized light and reflects circularly polarized light having a turning direction opposite to that of the transmitted circularly polarized light.

Examples of the reflective type circular polarizer include a reflective type circular polarizer including a cholesteric liquid crystal layer. The cholesteric liquid crystal layer is a liquid crystal phase obtained by fixing a cholesterically aligned liquid crystal phase (cholesteric liquid crystal phase).

As is well known, the cholesteric liquid crystal layer has a helical structure in which the liquid crystal compound is helically turned and laminated. In the helical structure, a configuration in which the liquid crystal compound is helically rotated once (rotated by 360°) and laminated is set as single helical period (the helical period), and the helically turned liquid crystal compounds are laminated a plurality of periods.

The cholesteric liquid crystal layer reflects levorotatory circularly polarized light or dextrorotatory circularly polarized light in a specific wavelength range and allows the transmission of the other light depending on the length of the helical period and the helical turning direction (sense) of the liquid crystal compound.

Therefore, in a case where the virtual reality display apparatus displays a color image, the reflective type circular polarizer may include, for example, a plurality of cholesteric liquid crystal layers including a cholesteric liquid crystal layer that has a central wavelength of selective reflection for red light, a cholesteric liquid crystal layer that has a central wavelength of selective reflection for green light, and a cholesteric liquid crystal layer that has a central wavelength of selective reflection for blue light.

In addition, in a case where the reflective type circular polarizer includes a cholesteric liquid crystal layer, a support and an alignment film for aligning a liquid crystal compound in the cholesteric liquid crystal layer may be provided.

A thickness of the reflective type circular polarizer may be appropriately adjusted depending on the kind of the reflective type circular polarizer and the like, such that polarized light to be reflected can be sufficiently reflected and polarized light to be transmitted can be sufficiently transmitted.

### [Reflective Linear Polarizer]

The virtual reality display apparatus according to the embodiment of the present invention can include a reflective linear polarizer. In some optical systems, the reflective linear polarizer can exhibit a function of reflecting a part of light emitted from the image display panel, reciprocating the light inside the optical system, and increasing the optical path length. From the viewpoint of suppressing stray light and ghosts, a reflective linear polarizer having a high degree of polarization is preferable.

As the reflective linear polarizer, a film obtained by stretching a dielectric multi-layer film, a wire grid polarizer, or the like as described in JP2011-053705A can be used. As a commercially available product thereof, a reflective type polarizer (trade name: APF, IQPE) manufactured by 3M Company, a wire grid polarizer (trade name: WGF) manufactured by Asahi Kasei Corporation, or the like can be suitably used.

In the virtual reality display apparatus according to the embodiment of the present invention, a curved surface-shaped substrate can be used as the base material (for example, the member between the second retardation layer 12 and the half mirror 40 in FIG. 2).

Here, the curved surface shape means a shape having a curvature of more than 0, and includes a curved surface shape which is a developable surface and a three-dimensional curved surface shape. The developable surface means a surface that can be developed on a plane without expanding and contracting each portion of the surface, and examples of the curved surface shape which is a surface that can be developed on a plane without expanding and contracting each portion of the surface include a surface corresponding to a part or all of a cylindrical peripheral surface, an elliptical cylindrical peripheral surface, a conical peripheral surface, and an elliptical conical peripheral surface; and the curved surface may be a convex curved surface or a concave curved surface. The three-dimensional curved surface means a curved surface that is not a plane deformation, that is, a curved surface that is not the developable surface, and examples of the three-dimensional curved surface shape include a surface corresponding to a part or all of a spherical surface, an elliptical surface, and the like, and a surface corresponding to a part or all of a curved surface having a cross section of a parabola, a hyperbola, and the like; and the three-dimensional curved surface may be a convex curved surface or a concave curved surface. It is sufficient that the curved surface-shaped substrate has the curved surface shape at least in a part thereof, and the curved surface-shaped substrate may have a shape in which a planar shape and a curved surface shape are combined, or may have a curved surface shape as a whole. In addition, the curved surface shape included in the curved surface-shaped substrate may consist of only one of the curved surface shape which is a developable surface or the three-dimensional curved surface shape, or may consist of a combination of the curved surface which is a developable surface and the three-dimensional curved surface, or a combination of the curved surface which is a developable surface and/or the three-dimensional curved surface, and a flat surface.

In the aspect of the present invention, it is preferable that the curved surface shape of the curved surface-shaped substrate is a lens shape. The lens-like curved surface shape means a curved surface shape in which the curvature is constant in all directions of the curved surface. Examples of the lens-like curved surface shape include a spherical surface, an elliptical spherical surface, a hemispherical surface, and a semi-elliptical spherical surface; and the lens-like curved surface shape may be a convex lens-like shape or a concave lens-like shape.

In the aspect of the present invention, it is preferable that the curved surface-shaped substrate satisfies the expression (1).

$$20 mm \leq R \leq 300 mm \qquad ( 1 )$$

[in the expression (1), R represents a curvature radius of a portion having the smallest curvature in the curved surface-shaped substrate]

The expression (1) means that a curvature radius of the most gentle curved surface of the curved surface-shaped substrate is 20 mm or more and 300 mm or less. The curvature radius R of the portion having the smallest curvature in the curved surface-shaped substrate (hereinafter, also simply referred to as “curvature radius R”) may be, for example, 250 mm or less or 200 mm or less. In addition, the curvature radius R is more preferably 25 mm or more, and still more preferably 30 mm or more. In a case where the curvature radius R is equal to or more than the above-described lower limit value, lamination properties are more likely to be further improved.

A curvature radius R′ of a portion having the largest curvature in the curved surface-shaped substrate (hereinafter, also simply referred to as “curvature radius R′”) is preferably 10 mm or more, more preferably 15 mm or more, still more preferably 20 mm or more, particularly preferably 25 mm or more, and especially preferably 30 mm or more. The curvature radius R′ may be, for example, 250 mm or less, 200 mm or less, or 150 mm or less.

In a case where the curved surface shape included in the curved surface-shaped substrate is a shape having the same curvature in all directions of the curved surface, such as a lens-like curved surface shape, a curvature radius R″ thereof is usually equal to or more than the lower limit value of the above-described curvature radius R′ and equal to or less than the upper limit value of the above-described curvature radius R.

The curved surface-shaped substrate is not particularly limited as long as it is made of a material capable of forming a desired curved surface shape, and may be appropriately selected from known materials depending on the desired curved surface shape, the use of the polarizing plate, and the like. Examples thereof include a glass base material, a film base material, and a metal base material. From the viewpoint of easily forming various curved surface shapes, the curved surface-shaped substrate is preferably formed of a glass base material or a film base material, and more preferably formed of a glass base material or a resin film base material.

Examples of a base material having translucency include a glass base material and a transparent resin film base material.

Examples of a resin constituting the resin film base material include polyolefin such as polyethylene, polypropylene, and a norbornene-based polymer; polyvinyl alcohol; polyethylene terephthalate; polyacrylic acid ester; cellulose ester; polyethylene naphthalate; polycarbonate; polysulfone; polyethersulfone; polyetherketone; polyphenylene sulfide; and polyphenylene oxide. From the viewpoint of forming the polarizer, a glass base material or a material having hardness similar to that of the glass base material is suitable as the base material.

The surface of the surface substrate may be subjected to a surface treatment such as a corona treatment and a plasma treatment, or a release treatment such as a silicone treatment. In addition, a hard coating treatment, an antireflection treatment, an antistatic treatment, or the like may be performed on the substrate surface on which the polarizer is not laminated.

A thickness of the curved surface-shaped substrate may be appropriately determined according to the curved surface shape, the material constituting the curved surface-shaped substrate, the use of the virtual reality display apparatus, and the like. The entire curved surface-shaped substrate may have the same thickness or may have different thicknesses. The thickness of the curved surface-shaped substrate is, for example, 30 μm to 5 cm, preferably 100 m to 3.5 cm and more preferably 500 μm to 3 cm.

### EXAMPLES

Hereinafter, the present invention will be described in more detail with reference to Examples. The materials, amounts used, proportions, treatment contents, treatment procedures, and the like shown in the following examples can be modified as appropriate in the range of not departing from the spirit of the present invention. Therefore, the scope of the present invention should not be construed as being limited to Examples.

### First Embodiment of Virtual Reality Display Apparatus

### Example 1

### [Production of Base Material 1]

The following composition was put into a mixing tank, stirred, and further heated at 90° C. for 10 minutes. Thereafter, the obtained composition was filtered through a filter paper having an average pore diameter of 34 μm and a sintered metal filter having an average pore diameter of 10 μm to prepare a dope. The concentration of solid contents of the dope was 23.5% by mass, the amount of the plasticizer added was a proportion to cellulose acylate, and the solvent of the dope was methylene chloride/methanol/butanol=81/18/1 (mass ratio).

Cellulose acylate dope

| | |
|---|---|
| Cellulose acylate (acetyl substitution degree: 2.86, | 100 parts by mass |
| viscosity average degree of polymerization: 310) | |
| Sugar ester compound 1 (Formula (S4) shown below) | 6.0 parts by mass |
| Sugar ester compound 2 (Formula (S5) shown below) | 2.0 parts by mass |
| Silica partical dispersion (AEROSIL R972, | 0.1 parts by mass |
| manufactured by Nippon Aerosil Co., Ltd.) | |
| Solvent (methylene chloride/methanol/butanol) | 351.9 parts by mass |

(S4) 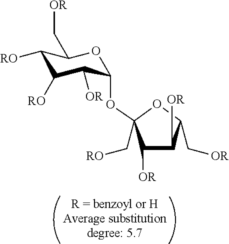
(S5)

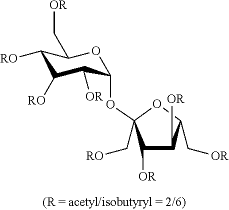

The dope produced above was cast using a drum film forming machine. The dope was cast from a die such that it was in contact with a metal support cooled to 0° C., and then the obtained web (film) was stripped from the drum. The drum was made of stainless steel (SUS).

The web (film) obtained by casting was peeled off from the drum, and then dried in a tenter device for 20 minutes at 30° C. to 40° C. during film transport, using the tenter device that clipped and transported both ends of the web. Subsequently, the web was post-dried by zone heating while being rolled. The obtained web was knurled and then wound up to obtain a base material 1.

In the obtained base material 1, a film thickness was 60 μm, an in-plane retardation Re (550) at a wavelength of 550 nm was 1 nm, and a thickness direction retardation Rth (550) at a wavelength of 550 nm was 35 nm.

### [Production of Photo-Alignment Film B1]

A composition B1 for forming a photo-alignment film, which will be described later, was continuously applied onto the above-described base material 1 with a wire bar. The support on which the coating film had been formed was dried with hot air at 140° C. and a wind speed of 1 m/s for 120 seconds, and the coating film was irradiated with polarized ultraviolet rays (10 mJ/cm², using an ultra-high pressure mercury lamp) to produce a photo-alignment film B1, thereby obtaining a base material 1 with a photo-alignment film. A film thickness of the photo-alignment film B1 was 1.5 μm.

As shown in Table 3 below, a concentration of solid contents of the composition B1 for forming a photo-alignment film was 20%, and a viscosity was 3.5 mPa·s.

In addition, in a case where a secondary ion intensity derived from the polymer compound PB-1 was measured by TOF-SIMS for the produced photo-alignment film with the above-described method, it was confirmed that the polymer compound PB-1 was unevenly distributed on the side opposite to the light absorption anisotropic layer (the base material 1 side).

In addition, an absolute value of a difference between the SP value of the polymer compound PB-1 in the composition B1 for forming a photo-alignment film and the SP value of the above-described base material 1 was 1.5 MPa^{1/2}.

Formulation of composition B1 for forming photo-alignment film

| | | |
|---|---|---|
| Polymer PA-1 (photo-alignment compound) | 100.00 | parts by mass |
| shown below | | |
| EPICLON N-695 (manufactured by DIC | 55.74 | parts by mass |
| Corporation) | | |
| jER YX7400 (manufactured by Mitsubishi | 18.75 | parts by mass |
| Chemical Corporation) | | |
| Polymer compound PB-1 shown below | 8.01 | parts by mass |
| Thermal cationic polymerization initiator | 16.75 | parts by mass |
| PAG-1 shown below | | |
| Stabilizer DIPEA shown below | 1.06 | parts by mass |
| Acid-cleavable surfactant SA-1 | 0.50 | parts by mass |
| shown below | | |
| Butyl acetate | 803 | parts by mass |

### Polymer PA-1 (Photo-Alignment Compound) (Weight-Average Molecular Weight: 32000)

(in the formulae, the numerical value described in each repeating unit denotes the content (% by mass) of each repetition unit with respect to all repeating units)

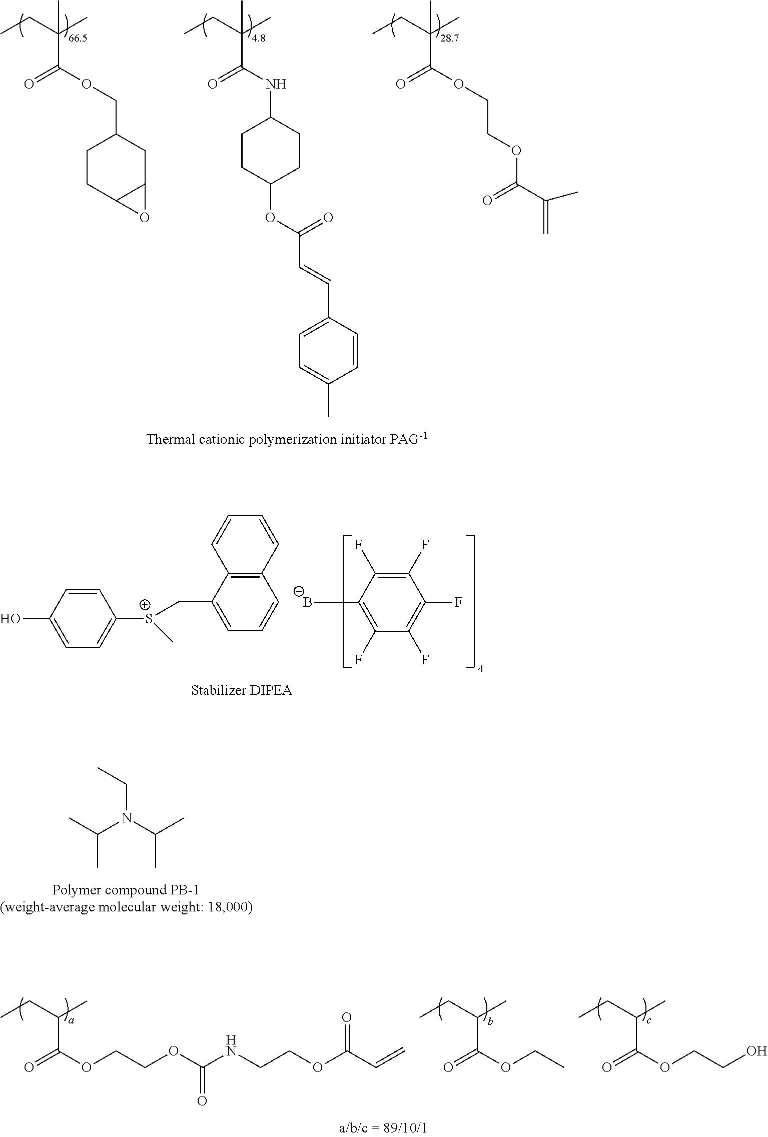

Acid-cleavable surfactant SA-1 (numerical value described in each repeating unit represents a content (% by mass) of each repeating unit with respect to all repeating units; in addition, a weight-average molecular weight was 78,000)

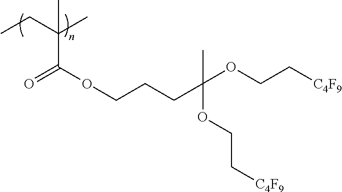

### [Formation of Light Absorption Anisotropic Layer C1]

A coating film was formed by continuously coating the obtained photo-alignment film B1 with a composition C1 for forming a light absorption anisotropic layer, having the following formulation, with a wire bar.

Next, the coating film was heated at 140° C. for 15 seconds, subjected to a heat treatment at 80° C. for 5 seconds, and cooled to room temperature (23° C.). Next, the coating film was heated at 75° C. for 60 seconds, and cooled to room temperature again.

Thereafter, the coating film was irradiated with a light emitting diode (LED) lamp (central wavelength: 365 nm) under an irradiation condition of 300 mJ, thereby forming a light absorption anisotropic layer (polarizer) C1 (thickness: 1.8 μm) on the photo-alignment film B1. The total content of the first dichroic substance Dye-C1, the second dichroic substance Dye-M1, and the third dichroic substance Dye-Y1 contained in the light absorption anisotropic layer C1 was 220 mg/cm³.

In a case where a transmittance of the light absorption anisotropic layer C1 in a wavelength range of 280 to 780 nm was measured with a spectrophotometer, and the average transmittance of visible light was 42%.

The absorption axis of the light absorption anisotropic layer C1 was in the plane of the light absorption anisotropic layer C1, and was orthogonal to a width direction of the cellulose acylate film A1.

Formulation of composition C1 for forming light absorption anisotropic layer

| | |
|---|---|
| First dichroic substance Dye-C1 shown below | 0.65 parts by mass |
| Second dichroic substance Dye-M1 shown below | 0.15 parts by mass |
| Third dichroic substance Dye-Y1 shown below | 0.52 parts by mass |
| Liquid crystal compound L-1 shown below | 2.69 parts by mass |
| Liquid crystal compound L-2 shown below | 1.15 parts by mass |
| Adhesion improver A-1 shown below | 0.17 parts by mass |
| Polymerization initiator IRGACURE OXE-02 (manufactured by BASF) | 0.17 parts by mass |
| Surfactant F-1 shown below | 0.013 parts by mass |
| Cyclopentanone | 92.14 parts by mass |
| Benzyl alcohol | 2.36 parts by mass |

Dichroic substance Dye-C1 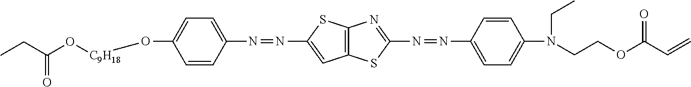
Dichroic substance Dye-M1 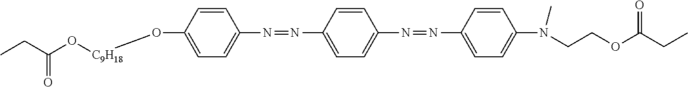
Dichroic substance Dye-Y1

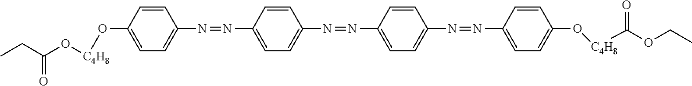

Liquid crystal compound L-1 (Weight-Average Molecular Weight: 18,000)
(in the formulae, the numerical values (“59”, “15”, and “26”) described in each repeating unit denote the content (% by mass) of each repetition with respect to all repeating units)

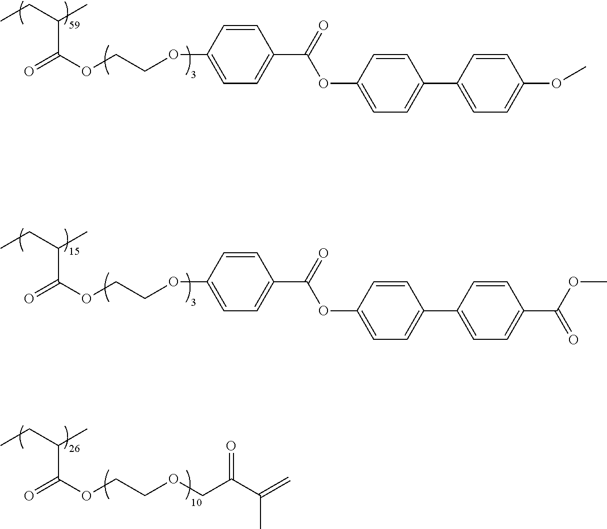

Liquid crystal compound L-2 (mixture of the following liquid crystal compounds (RA), (RB), and (RC) at a mass ratio of 84:14:2)

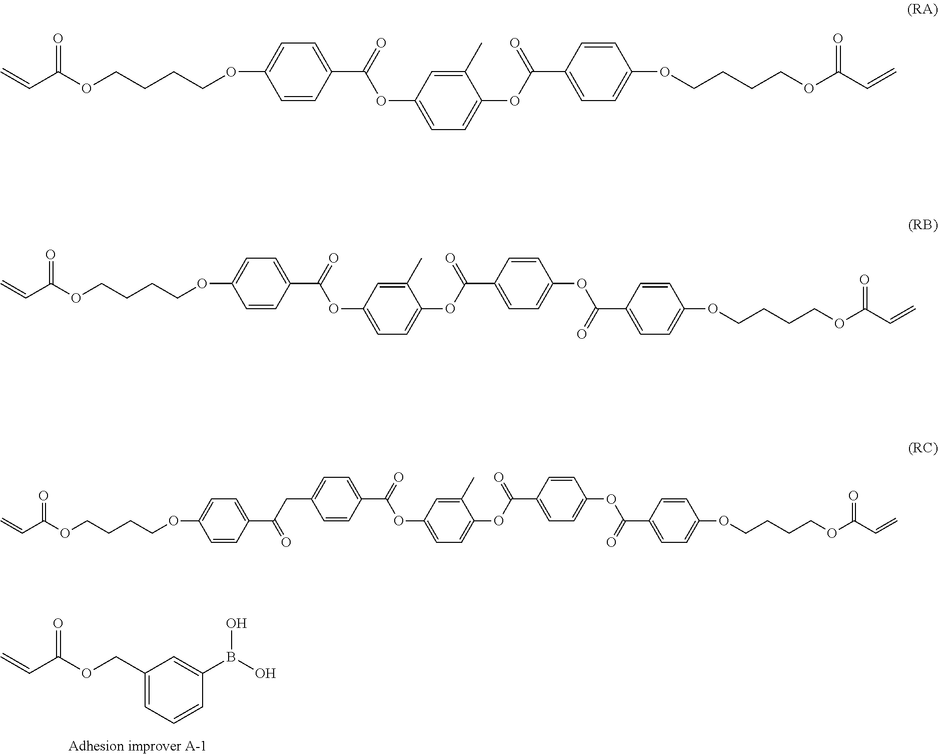

### Surfactant F-1 (Weight-Average Molecular Weight: 15,000)

(in the formulae, the numerical value described in each repeating unit denotes the content (% by mass) of each repetition with respect to all repeating units; Ac means —C(O)CH₃)

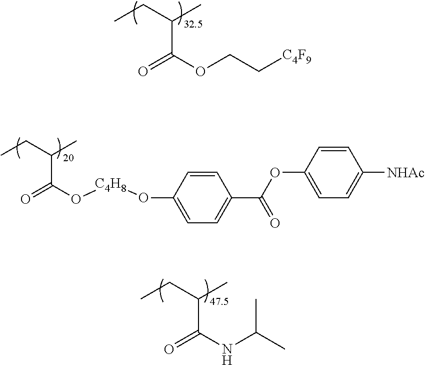

### [Formation of Protective Layer D1]

The light absorption anisotropic layer C1 was continuously coated with a coating liquid D1 having the following formulation with a wire bar.

Thereafter, the layer was dried with hot air at 80° C. for 5 minutes, thereby obtaining a laminate in which a protective layer D1 consisting of polyvinyl alcohol (PVA) and having a thickness of 0.6 μm was formed, that is, a laminate 1 in which the base material 1 (base material), the photo-alignment film B1, the light absorption anisotropic layer C1, and the protective layer D1 were provided adjacent to each other in this order.

An oxygen permeability coefficient of the protective layer D1 was 6 cc/m²·day·atm.

Formulation of coating liquid D1 for forming protective layer

| | | |
|---|---|---|
| Modified polyvinyl alcohol shown below | 3.31 | parts by mass |
| Initiator IRGACURE 2959 (manufactured | 0.17 | parts by mass |
| by BASF) | | |
| Glutaraldehyde | 0.07 | parts by mass |
| Pyridinium paratoluene sulfonate | 0.05 | parts by mass |
| Surfactant F-9 shown below | 0.0018 | parts by mass |
| Water | 74.0 | parts by mass |
| Ethanol | 22.4 | parts by mass |

### Modified Polyvinyl Alcohol (Weight-Average Molecular Weight: 28000)

(in the formula, the numerical value described in each repeating unit denotes the content (% by mass) of each repetition with respect to all repeating units)

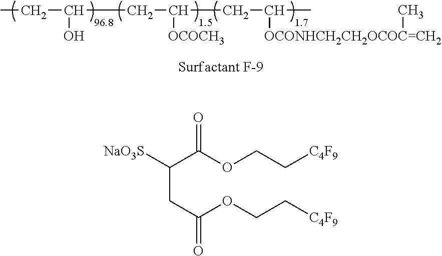

### Example 2

A laminate 2 was produced by the same method as in Example 1, except that the following surfactant F-1 (weight-average molecular weight: 15,000) was used instead of the acid-cleavable surfactant SA-1 which had been blended in the composition for forming a photo-alignment film.

### <Surfactant F-1>

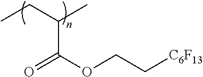

### Example 3

A laminate 3 was produced by the same method as in Example 1, except that the protective layer D1 was not formed.

### Example 4

A laminate 4 was produced by the same method as in Example 1, except that the acid-cleavable surfactant SA-1 was not blended in the composition for forming a photo-alignment film.

### Example 5

A laminate 5 was produced by the same method as in Example 1, except that the acid-cleavable surfactant SA-1 was not blended in the composition for forming a photo-alignment film, the blending amount of butyl acetate was adjusted to set the concentration of solid contents to 10%, and the viscosity was set to 1.1 mPa·s.

### Comparative Example 1

A laminate H1 was produced by the same method as in Example 5, except that the wind speed during the drying after the application of the composition for forming a photo-alignment film was changed from 1 m/s to 6 m/s.

### Example 6

### [Formation of Light Absorption Anisotropic Layer C2]

The following components were mixed and stirred at 80° C. for 1 hour to obtain a composition C2 for forming a light absorption anisotropic layer.

Composition C2 for forming light absorption anisotropic layer

| | | |
|---|---|---|
| Polymerizable liquid crystal compound (1-6) | 75 | parts by mass |
| shown below | | |
| Polymerizable liquid crystal compound (1-7) | 25 | parts by mass |
| shown below | | |
| Dichroic substance A1 shown below | 3 | parts by mass |
| Dichroic substance A2 shown below | 3 | parts by mass |
| Dichroic substance A3 shown below | 1 | part by mass |
| Dichroic substance A4 shown below | 1 | part by mass |
| 2-Dimethylamino-2-benzyl-1-(4-morpholino- | 6 | parts by mass |
| phenyl)butan-1-one (IRGACURE 369, | | |
| manufactured by BASF) | | |
| Polyacrylate Compound (BYK-361N; | 1.2 | parts by mass |
| manufactured by BYK-Chemie GmbH) | | |
| o-Xylene | 250 | parts by mass |

Among these dichroic substances, the dichroic substance A3 and the dichroic substance A4 were dichroic substances having a maximal absorption wavelength in a wavelength range of 550 to 700 nm.

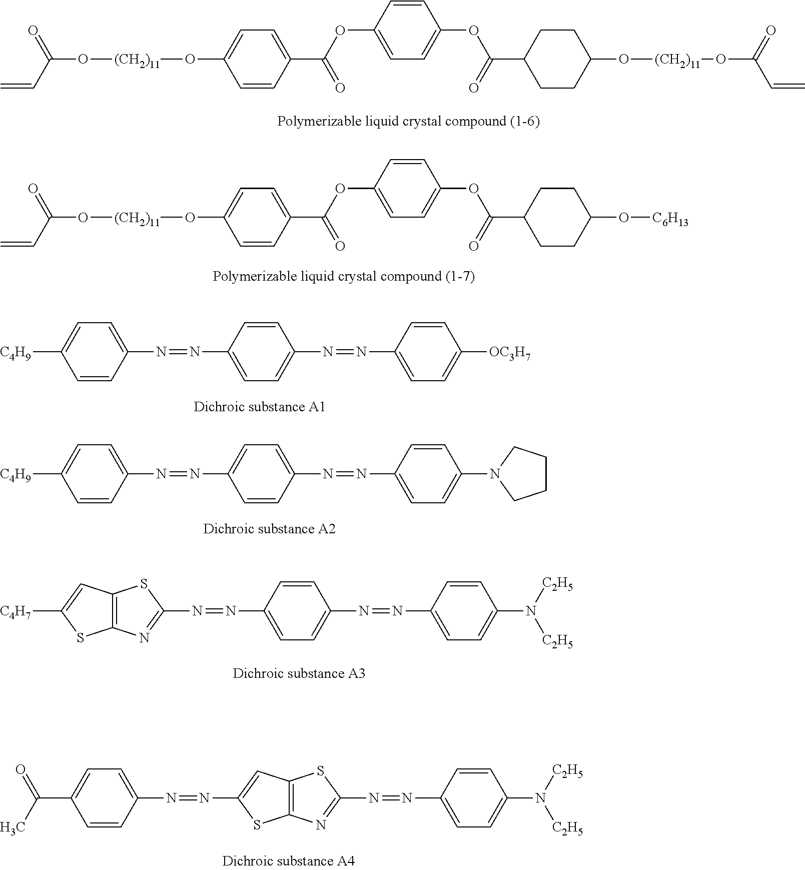

Next, the composition C1 for forming a light absorption anisotropic layer was applied onto the photo-alignment film B1 of the base material 1 with a photo-alignment film, which had been produced by the same method as in Example 1, using a slot die coater to form a coating film. In addition, the coating film was transported through a ventilation drying furnace set to 110° C. for 2 minutes so that the solvent was removed, and the coating film was rapidly cooled to obtain a dried coating film.

Thereafter, the dried coating film was irradiated with ultraviolet light at 1,000 mJ/cm² (365 nm basis) using a high-pressure mercury lamp to cure the polymerizable liquid crystal contained in the dried coating film, thereby forming a light absorption anisotropic layer C2. The total content of the dichroic substances A1 to A4 contained in the light absorption anisotropic layer C2 was 50 mg/cm³.

Next, the same protective layer D1 as in Example 1 was formed on the light absorption anisotropic layer C2 to obtain a laminate 6 in which the base material 1 (base material), the photo-alignment film B1, the light absorption anisotropic layer C2, and the protective layer D1 were provided adjacent to each other in this order.

### [Evaluation]

### [Film Thickness Variation]

For the produced laminate, film thickness variation of the alignment film was calculated by the above-described method. The results are shown in Table 3 below.

### [Display Performance]

### <Production of Retardation Layer 1>

A retardation layer 1 having reverse dispersibility was produced with reference to the method described in paragraphs [0151] to [0163] of JP2020-084070A. Re of the retardation layer 1 was 146 nm and Rth thereof was 73 nm.

### <Production of Virtual Reality Display Apparatus>

A virtual reality apparatus having the configuration shown in FIG. 2 was produced, and it was confirmed that the virtual reality apparatus operated as a virtual reality apparatus. Thereafter, the virtual reality apparatus was disassembled, and the second absorption type linear polarizer, the second retardation layer, and the half mirror on the viewing side in FIG. 2 were removed.

Next, a commercially available laminated film (PAC-3J-30H, thickness: 30 μm, manufactured by Sun AKaken Co., Ltd.) was bonded to the protective layer (the light absorption anisotropic layer for the laminate produced in Example 3) side of each produced laminate, and then the base material 1 was peeled off.

Next, the retardation layer 1 was bonded to the exposed photo-alignment film side of the laminate using a pressure-sensitive adhesive sheet “NCF-D692 (5)” manufactured by LINTEC Corporation.

Next, a half mirror made of PMMA was prepared, the laminate on the retardation layer side was bonded to a surface of the half mirror opposite to the reflecting surface using a pressure-sensitive adhesive sheet “NCF-D692 (5)” manufactured by LINTEC Corporation, the laminated film was peeled off, and the produced half mirror was incorporated into the virtual reality display apparatus.

### <Evaluation of Distortion of VR Image>

In the produced virtual reality display apparatuses, a black-and-white checker pattern was displayed on the image display panel, and a degree of distortion of the VR image was evaluated by visual observation in the following three stages. The results are shown in Table 3 below.
A: distortion of the VR image was not visible.
B: distortion of the VR image was slightly visible, but was not noticeable.
C: distortion of the VR image was visible, but there was no problem in practical use.
D: distortion of VR image was clearly visible.

### [Durability]

A pressure-sensitive adhesive sheet “NCF-D692 (5)” manufactured by LINTEC Corporation was bonded to the protective layer D (the light absorption anisotropic layer for the laminate produced in Example 3) side of each produced laminate, and a commercially available cellulose acylate-based film, trade name “FUJITAC TG40UL” (manufactured by FUJIFILM Corporation) was bonded as a transparent base material film, and the base material 1 was peeled off.

Next, a pressure-sensitive adhesive sheet “NCF-D692 (5)” manufactured by LINTEC Corporation was bonded to a peeling surface of the base material 1 to prepare a sample attached to glass, the sample was set in a constant-temperature and constant-humidity tank, and a durability test was performed by storing the sample for 500 hours under the conditions of 65° C. and 90% RH.

A change ΔT in transmittance was obtained from the values of the transmittance before and after the durability test. As the value of ΔT is closer to 0, the durability is more excellent. A to C are levels which do not cause any problems in practical use. The results are shown in Table 3 below.
A: change in transmittance was 0.0% or more and less than 1.0%.
B: change in transmittance was 1.0% or more and less than 3.0%.
C: change in transmittance was 3.0% or more and less than 5.0%.
D: change in transmittance was 5.0% or more.

### [Cissing]

The number of cissing in 1 m² of the obtained laminate film was counted. Here, a region in which the light absorption anisotropic layer was not formed in the surface of the photo-alignment film was defined as the cissing. Based on the results, evaluation was performed according to the following standard. A and B are levels which do not cause any problems in practical use. The results are shown in Table 3 below.
A: number of cissing was 3 or less.
B: number of cissing was more than 3 and 10 or less.
C: number of cissing was more than 10.

TABLE 3

| | | Photo-alignment film | | | | | | | | | | | |
|---|---|---|---|---|---|---|---|---|---|---|---|---|---|
| | | (composition for forming photo-alignment film) | | | | | | | | | | | |
| | | | | | | | | Film | Light | | | | |
| | | | | | Concen- | Wind | | thick- | absorption | | | | |
| | | Photo- | | | tration | speed | | ness | aniso- | Pro- | Display | | |
| | Base | alignment | | Polymer | of solid | during | Viscosity | varia- | tropic | tective | perfor- | Dura- | |
| | material | compound | Surfactant | compound | contents | drying | (mPa · s) | tion | layer | layer | mance | bility | Cissing |
| Example 1 | Base | PA-1 | SA-1 | PB-1 | 20% | 1 m/s | 3.5 | <3% | C1 | D1 | A | A | A |
| | material 1 | | | | | | | | | | | | |
| Example 2 | Base | PA-1 | F-1 | PB-1 | 20% | 1 m/s | 3.5 | <3% | C1 | D1 | A | A | C |
| | material 1 | | | | | | | | | | | | |
| Example 3 | Base | PA-1 | SA-1 | PB-1 | 20% | 1 m/s | 3.5 | <3% | C1 | — | A | C | A |
| | material 1 | | | | | | | | | | | | |
| Example 4 | Base | PA-1 | — | PB-1 | 20% | 1 m/s | 3.5 | 3% | C1 | D1 | B | A | A |
| | material 1 | | | | | | | | | | | | |
| Example 5 | Base | PA-1 | — | PB-1 | 10% | 1 m/s | 1.1 | 6% | C1 | D1 | C | A | A |
| | material 1 | | | | | | | | | | | | |
| Comparative | Base | PA-1 | — | PB-1 | 10% | 6 m/s | 1.1 | 11% | C1 | D1 | D | A | A |
| Example 1 | material 1 | | | | | | | | | | | | |
| Example 6 | Base | PA-1 | SA-1 | PB-1 | 20% | 1 m/s | 3.5 | <3% | C2 | D1 | C | A | A |
| | material 1 | | | | | | | | | | | | |

From the results shown in Table 3, it was found that, in a case where a laminate in which the film thickness variation of the alignment film was more than 10% was used, the virtual image (VR image) was distorted and the display performance was deteriorated (Comparative Example 1).

On the other hand, it was found that, in a case where a laminate in which the viscosity of the composition for forming an alignment film and the drying conditions were changed and the film thickness variation of the alignment film was set to 10% or less was used, the display performance was improved (Examples 1 to 6).

In particular, from the comparison of Examples 1, 2, and 4, it was found that, in a case where the acid-cleavable surfactant was blended in the composition for forming an alignment film, the cissing during the formation of the light absorption anisotropic layer could be suppressed.

In addition, from the comparison between Example 1 and Example 3, it was found that, in a case where the laminate including the protective layer was used, the durability was improved. In addition, from the comparison between Example 4 and Example 5, it was found that, in a case where the viscosity of the composition for forming an alignment film was 2 mPa·s or more and less than 10 mPa·s, it was easy to adjust the film thickness variation of the formed alignment film to 10% or less, and as a result, the display performance was further improved.

### Third Embodiment of Virtual Reality Display Apparatus

### [Production of Molded Body]

### [Production of Optically Anisotropic Film]

A commercially available laminated film (PAC-3J-30H, thickness: 30 μm, manufactured by Sun A Kaken Co., Ltd.) was bonded to the protective layer side of the laminate 1, and then the base material 1 was peeled off.

Next, the retardation layer 1 was bonded using a pressure-sensitive adhesive sheet “NCF-D692 (5)” manufactured by LINTEC Corporation, and then the support used in the production of the retardation layer 1 was peeled off to produce an optically anisotropic film 1 with a laminated film. In this case, the laminate 1 and the retardation layer 1 were laminated such that the absorption axis orientation of the laminate 1 and the slow axis orientation of the retardation layer 1 formed an angle of 45°.

### [Production of Molded Body]

A pressure-sensitive adhesive sheet “NCF-D692 (5)” manufactured by LINTEC Corporation was attached to the retardation layer 1 side, and the optically anisotropic film 1 with a laminated film was subjected to vacuum molding along a concave surface of a plano-concave lens (made of optical glass) having a diameter of 50 mm and a curvature radius of 90 mm with reference to JP2012-116094A, in a state in which a separator film of the pressure-sensitive adhesive sheet was peeled off. In this case, the retardation layer 1 side was formed to be in contact with the plano-concave lens. Thereafter, the laminated film was peeled off from the lens to produce a molded body 1 laminated on the plano-concave lens.

Molded bodies 2 to 5 and a molded body H1 were produced by the same method as that for the molded body 1, except that the laminate 1 was changed to the laminates 2 to 5 and the laminate H1.

### [Evaluation]

### [Film Thickness Variation]

For the produced molded bodies, the film thickness variation of the curved surface-molded alignment film was calculated while tilting the stage in the above-described interference film thickness measuring device. In this case, the measurement was performed by measuring 101 points at a distance of 40 mm in any direction passing through the center portion of the lens at a pitch of 0.4 mm. The results are shown in Table 6 below.

### [Production of Reflective Type Circular Polarizer]

<Preparation of coating liquids R-1 and R-2, and D-1 and D-2 for Reflective Layer>

A composition shown below was stirred and dissolved in a container held at 70° C. to prepare a coating liquid R-1 for a reflective layer.

(Coating liquid R-1 for reflective layer)

| | | |
|---|---|---|
| Methyl ethyl ketone | 120.9 | parts by mass |
| Cyclohexanone | 21.3 | parts by mass |
| Mixture of rod-like liquid crystals shown below | 100.0 | parts by mass |
| Photopolymerization initiator b shown below | 1.00 | part by mass |
| Chiral agent A shown below | 3.00 | parts by mass |
| Surfactant F2 shown below | 0.027 | parts by mass |
| Surfactant F3 shown below | 0.067 | parts by mass |

### (Coating Liquid R-2 for Reflective Layer)

A coating liquid R-2 for a reflective layer was prepared by the same method as that for the coating liquid R-1 for a reflective layer, except that the addition amount of the chiral agent A was changed as shown in Table 4.

TABLE 4

| | Amount of chiral agent |
|---|---|
| Coating liquid name | (part by mass) |
| Liquid R-1 | 3.00 |
| Liquid R-2 | 3.62 |

Mixture of rod-like liquid crystals [mixture of the following liquid crystal compounds (RA), (RB), and (RC) with 84:14:2 (mass ratio); average molar absorption coefficient at a wavelength of 300 to 400 nm: 140/mol·cm]

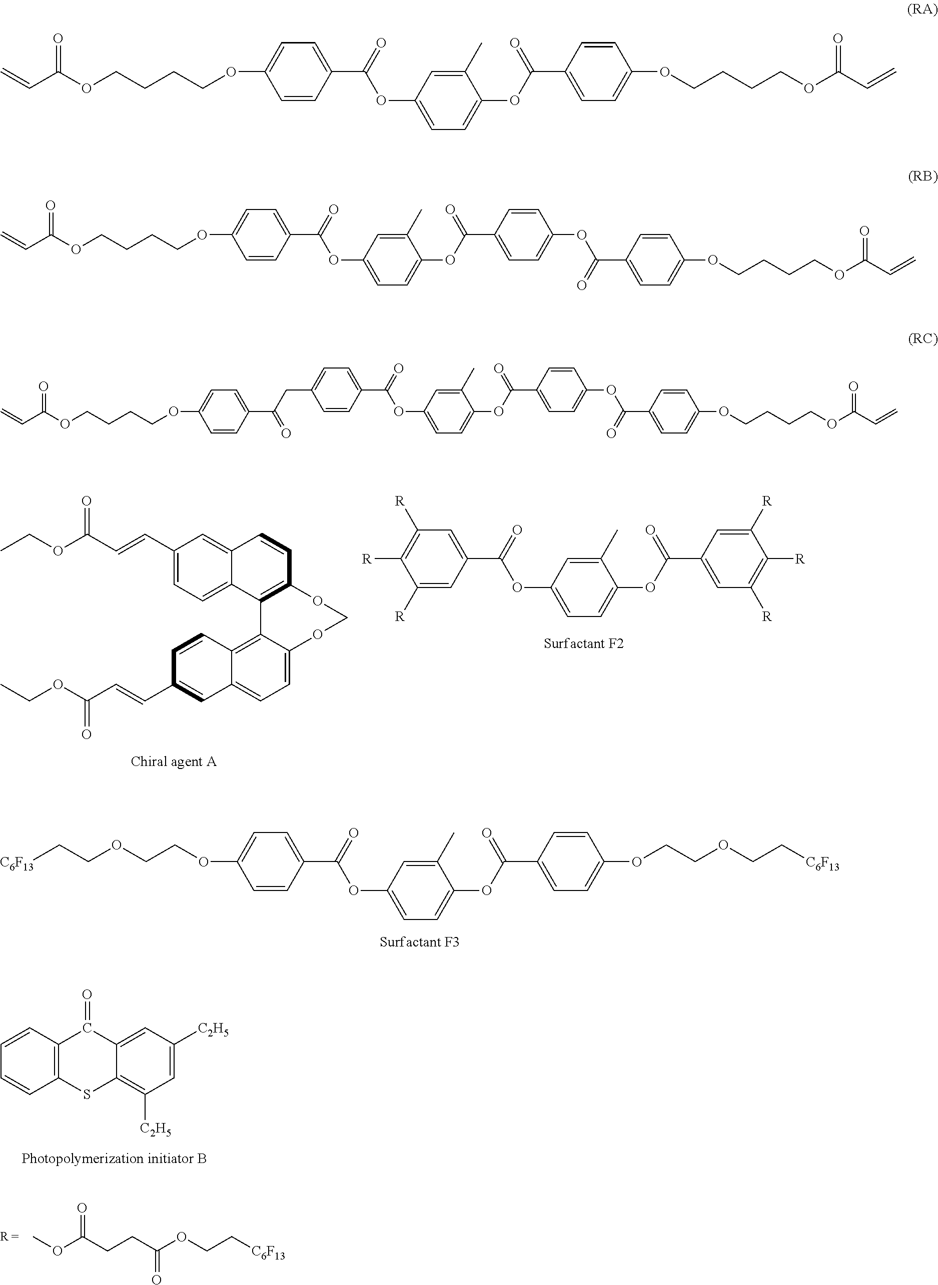

The chiral agent A was a chiral agent in which the helical twisting power (HTP) was reduced by light.

(Coating liquid D-1 for reflective layer)

A composition shown below was stirred and dissolved in a container held at 50° C. to prepare a coating liquid D-1 for a reflective layer.

Coating liquid D-1 for reflective layer

| | | |
|---|---|---|
| Disc-like liquid crystal (A) shown below | 80 | parts by mass |
| Disc-like liquid crystal (B) shown below | 20 | parts by mass |
| Polymerizable monomer EM1 shown below | 10 | parts by mass |
| Surfactant F4 shown below | 0.3 | parts by mass |
| Photopolymerization initiator (IRGACURE 907 | 3 | parts by mass |
| manufactured by BASF) | | |
| Chiral agent A shown above | 4.00 | parts by mass |
| Methyl ethyl ketone | 290 | parts by mass |
| Cyclohexanone | 50 | parts by mass |

### (Coating Liquid D-2 for Reflective Layer)

A coating liquid D-2 for a reflective layer was prepared by the same method as that for the coating liquid D-1 for a reflective layer, except that the addition amount of the chiral agent A was changed as shown in Table 5.

TABLE 5

| | Amount of chiral agent |
|---|---|
| Coating liquid name | (part by mass) |
| Liquid D-1 | 4.00 |
| Liquid D-2 | 5.30 |

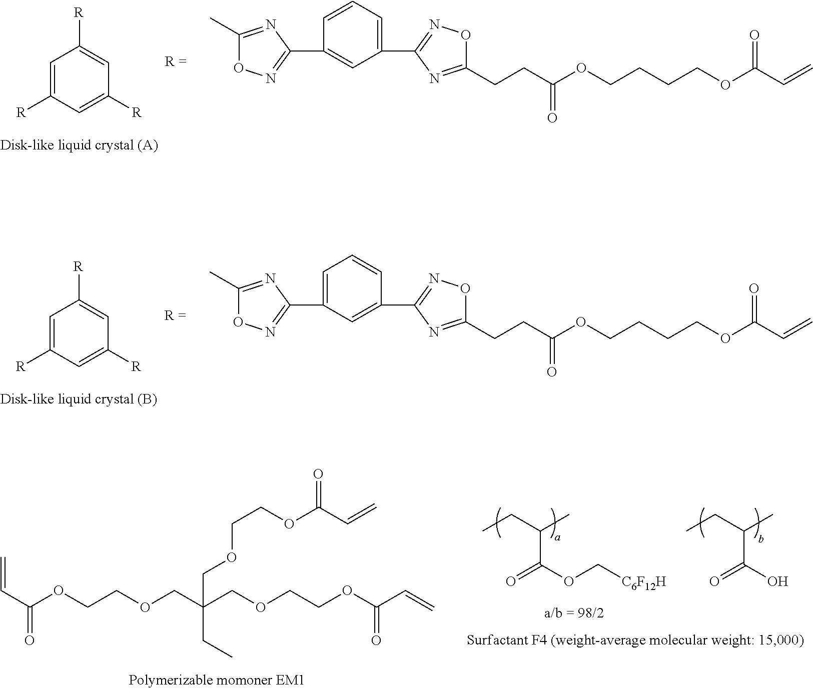

### [Production of Reflective Type Circular Polarizer 1]

A polyethylene terephthalate (PET) film (A4100 manufactured by Toyobo Co., Ltd.) having a thickness of 50 μm was prepared as a temporary support. The PET film had an easy adhesion layer on one surface.

A surface of the PET film, which was not provided with the easy adhesion layer, was subjected to a rubbing treatment, coated with the coating liquid R-1 for a reflective layer prepared above using a wire bar coater, and dried at 110° C. for 120 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a red light reflecting layer consisting of a cholesteric liquid crystal layer. The irradiation with light was performed from the side of the cholesteric liquid crystal layer in all cases. Here, the coating thickness was adjusted so that the film thickness of the cured red light reflecting layer was 4.5 μm.

Next, the surface of the red light reflecting layer was subjected to a corona treatment at a discharge amount of 150 W min/m², and the surface subjected to the corona treatment was coated with the coating liquid D-1 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a yellow light reflecting layer on the red light reflecting layer. The irradiation with light was performed from the side of the cholesteric liquid crystal layer in all cases. Here, the coating thickness was adjusted so that the film thickness of the cured yellow light reflecting layer was 3.3 μm.

Next, the yellow light reflecting layer was coated with the coating liquid R-2 for a reflective layer using a wire bar coater and dried at 110° C. for 120 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a green light reflecting layer on the yellow light reflecting layer. The irradiation with light was performed from the side of the cholesteric liquid crystal layer in all cases. Here, the coating thickness was adjusted so that the film thickness of the cured green light reflecting layer was 2.7 μm.

Next, the surface of the green light reflecting layer was subjected to a corona treatment at a discharge amount of 150 W min/m², and the surface subjected to the corona treatment was coated with the coating liquid D-2 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a blue light reflecting layer on the green light reflecting layer. The irradiation with light was performed from the side of the cholesteric liquid crystal layer in all cases. Here, the coating thickness was adjusted so that the film thickness of the cured blue light reflecting layer was 2.5 μm.

In this manner, a reflective type circular polarizer 1 was produced.

### [Production of Optical Lens]

A pressure-sensitive adhesive sheet “NCF-D692 (5)” manufactured by LINTEC Corporation was attached to the blue light reflecting layer side of the reflective type circular polarizer 1, and the reflective type circular polarizer 1 was subjected to vacuum molding with reference to JP2012-116094A such that the reflective type circular polarizer 1 was along a concave surface of a plano-concave lens (made of optical glass) having a diameter of 50 mm and a curvature radius of 90 mm and the blue light reflecting layer side was in contact with the plano-concave lens, in a state in which a separator film of the pressure-sensitive adhesive sheet was peeled off. Thereafter, the PET base material of the reflective type circular polarizer 1 was peeled off from the lens to obtain a lens with a reflective type circular polarizer.

Next, the retardation layer side of the optically anisotropic film 1 (retardation layer 1/photoalignment layer/light absorption anisotropic layer/pressure-sensitive adhesive layer/laminated film) with a laminated film of Example 1 was overlapped with the reflective type circular polarizer 1 and molded by the same method as described above. In this manner, an optical lens 1 in which the lens, the reflective type circular polarizer 1, the pressure-sensitive adhesive layer, the retardation layer 1, the photoalignment layer, and the light absorption anisotropic layer were laminated in this order was produced.

### [Production of Virtual Reality Display Apparatus]

A virtual reality display apparatus “VIVE FLOW” manufactured by HTC Corporation was disassembled, and an optical lens was taken out. The “VIVE FLOW” is a virtual reality display apparatus in which a pancake lens is adopted, and a liquid crystal display device which emits circularly polarized light by a polarizing plate bonded to a surface is used as an image display device.

In addition, the taken optical lens was two types of lenses, one of which was a biconvex lens having a half-mirror coating on one surface and the other of which was a plano-convex lens having an optical laminate bonded to a plane.

The above-described plano-convex lens was removed, and the produced optical lens 1 was installed such that the plane side was on the side of the above-described biconvex lens. In this case, the optical lens 1 was installed while adjusting the distance from the biconvex lens, so that the virtual reality display image was displayed properly.

In this way, a virtual reality display apparatus 1 using the molded body 1 of Example 1 was produced.

In addition, virtual reality display apparatuses 2 to 5 and H1 were produced by the same method as described above, except that the molded body 1 was changed to the molded bodies 2 to 5 and H1.

### [Evaluation]

In each of the produced virtual reality display apparatuses, a black-and-white checker pattern was displayed on the image display device, and a degree of light leakage was evaluated by visual observation in the following four stages. The results are shown in Table 6 below. In a case where there was light leakage, double images were visually recognized, and a contrast of the corresponding portion was lowered.
A: double images were not visible at all.
B: double images were slightly visible, but not noticeable.
C: double images were visible, but there was no problem in practical use.
D: double images were clearly observed.

TABLE 6

| | Film thickness variation | Evaluation of light |
|---|---|---|
| | of photo-alignment film | leakage |
| Laminate 1 | <3% | A |
| Laminate 2 | <3% | A |
| Laminate 3 | <3% | A |
| Laminate 4 | 4% | B |
| Laminate 5 | 7% | C |
| Laminate H1 | 13% | D |

From the results shown in Table 6, it was found that, in a case where a laminate in which the film thickness variation of the alignment film was 10% or less was used, the light leakage was reduced and the display performance was improved (molded bodies 1 to 5 of Examples 1 to 5).

### Fourth Embodiment of Virtual Reality Display Apparatus

### Example 7

### [Production of Circularly Polarizing Plate]

The retardation layer 1 was bonded to the light absorption anisotropic layer side of the laminate 3 produced in Example 3 using a pressure-sensitive adhesive sheet “NCF-D692 (5)” manufactured by LINTEC Corporation to produce a circularly polarizing plate 7 having a configuration of alignment film/light absorption anisotropic layer/adhesive layer/phase difference layer 1. A film thickness of the adhesive layer was 5 μm, and an oxygen permeability coefficient thereof was more than 200 cc/m²·day·atm.

### [Production of Virtual Reality Display Apparatus]

A virtual reality display apparatus “Meta Quest Pro” manufactured by Meta Platforms, Inc. was disassembled, and optical lenses were taken out. The “Meta Quest Pro” is a virtual reality display apparatus in which a pancake lens is adopted, and a liquid crystal display device which emits circularly polarized light by a polarizing plate bonded to a surface is used as an image display device.

In addition, the optical lenses were two lens of a convex planar lens 1 in which a half mirror coating was performed on a convex surface and a phase difference film and an antireflection film were bonded to a plane, and a convex planar lens 2 in which an optical laminate (reflective type linear polarizer/glass/absorption type linear polarizer/retardation layer/lens) was bonded to a plane side and an antireflection film was bonded to a convex surface side.

The absorption type linear polarizer/retardation layer of the above-described convex planar lens 2 was removed, and the circularly polarizing plate 7 produced above was replaced with such that the light absorption anisotropic layer side was on the reflective type linear polarizer side by aligning the transmission axes with each other. In this case, the convex planar lens 1 was installed while adjusting the distance to the convex planar lens 2 so that the virtual reality display image was appropriately displayed, and thus the virtual reality display apparatus 7 of Example 7 was obtained.

### Example 8

### <Preparation of UV Adhesive 1>

A UV adhesive 1 having the following formulation was prepared.

UV adhesive 1

| | |
|---|---|
| CEL2021P (manufactured by Daicel Corporation) | 70 parts by mass |
| 1,4-Butanediol diglycidyl ether | 20 parts by mass |
| 2-Ethylhexyl glycidyl ether | 10 parts by mass |
| CPI-100P | 2.25 parts by mass |

CPI-100P

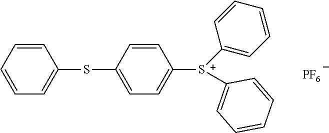

A virtual reality display apparatus 8 of Example 8 was produced by the same method as in Example 7, except that the adhesive layer of the circularly polarizing plate 7 was changed to a UV adhesive layer consisting of the UV adhesive 1, and exposed and cured at an illuminance of 1,000 mJ. An oxygen permeability coefficient of the UV adhesive layer was 200 cc/m²·day·atm or less.

### Example 9

### <Preparation of PVA Adhesive 1>

A PVA adhesive 1 having the following formulation was prepared.

20 parts by mass of methylol melamine with respect to 100 parts by mass of a polyvinyl alcohol-based resin containing an acetoacetyl group (average degree of polymerization: 1200, degree of saponification: 98.5% by mole, degree of acetoacetylation: 5% by mole) was dissolved in pure water under a temperature condition of 30° C. to prepare an aqueous solution (PVA adhesive 1) in which the concentration of solid contents was adjusted to 3.7%.

A virtual reality display apparatus 9 of Example 9 was produced by the same method as in Example 7, except that the adhesive layer of the circularly polarizing plate 7 was changed to a PVA adhesive layer consisting of the PVA adhesive 1. A film thickness of the PVA adhesive layer was 1 μm, and an oxygen permeability coefficient thereof was 200 cc/m²·day·atm or less.

### Example 10

A virtual reality display apparatus 10 of Example 10 was produced using a polymer-stretched reverse dispersion retardation polycarbonate film (manufactured by Teijin Limited, trade name: PURE-ACE RM; Re (550)=147 nm) instead of the liquid crystal cured retardation film 1 of Example 9.

### [Evaluation]

In each of the produced virtual reality display apparatuses, the distortion of the VR image and the durability were evaluated.

TABLE 7

| | Film thickness | | |
|---|---|---|---|
| | variation of photo- | Display | |
| | alignment film | performance | Durability |
| Example 7 | <3% | A | C |
| Example 8 | <3% | A | A |
| Example 9 | <3% | A | A |
| Example 10 | <3% | A | A |

From the results shown in Table 7, it was found that, in a case where a laminate in which the film thickness variation of the alignment film was 10% or less was used, the display performance was improved (Examples 7 to 10). In addition, it was found that, even in a configuration without the protective layer, the durability was excellent in a case where a pressure-sensitive adhesive layer having an oxygen permeability coefficient of 200 cc/m²·day·atm or less was used.

### EXPLANATION OF REFERENCES

100: virtual reality display apparatus
11: first retardation layer
12: second retardation layer
13: third retardation layer
21: first absorption type linear polarizer
22: second absorption type linear polarizer
30: reflective type circular polarizer
40: half mirror
50: antireflection layer
60: positive C-plate
70: image display panel

What is claimed is:

1. A laminate comprising:
an alignment film; and
a light absorption anisotropic layer provided on the alignment film,
wherein the light absorption anisotropic layer contains a liquid crystal compound and a dichroic substance, and
a film thickness variation of the alignment film is 10% or less.

2. The laminate according to claim 1,
wherein the dichroic substance contains a dichroic azo coloring agent compound having a thienothiazole skeleton.

3. The laminate according to claim 1,
wherein a content of the dichroic substance contained in the light absorption anisotropic layer is 40 to 250 mg/cm³.

4. The laminate according to claim 1,
wherein the alignment film contains a polymer compound, and
in a case where a secondary ion intensity derived from the polymer compound in the alignment film is measured by time-of-flight secondary ion mass spectrometry while irradiating the alignment film with an ion beam from a surface of the alignment film on a light absorption anisotropic layer side toward a surface opposite to the light absorption anisotropic layer, a maximum value of the secondary ion intensity derived from the polymer compound is present in a region from the surface opposite to the light absorption anisotropic layer to a position at a thickness of 100 nm.

5. The laminate according to claim 4,
wherein the polymer compound has a repeating unit represented by Formula (2), 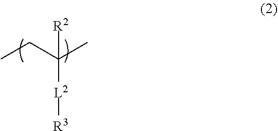
in Formula (2),
R² represents a hydrogen atom or an alkyl group having 1 to 4 carbon atoms,
L² represents a single bond or a divalent linking group,
R³ represents an aliphatic hydrocarbon group which may have a substituent or a group in which one or more of —CH₂-'s constituting the aliphatic hydrocarbon group are substituted with —O—, —S—, —NH—, —N(Q)-, or —CO—, and
Q represents a substituent.

6. The laminate according to claim 1, further comprising:
a protective layer on a side of the light absorption anisotropic layer opposite to the alignment film,
wherein an oxygen permeability coefficient of the protective layer is 200 cc/m²·day·atm or less.

7. The laminate according to claim 6,
wherein the protective layer consists of a polyvinyl alcohol-based resin film.

8. The laminate according to claim 1,
wherein the alignment film, the light absorption anisotropic layer, a pressure-sensitive adhesive layer, and a retardation layer are provided adjacent to each other in this order.

9. The laminate according to claim 8,
wherein an oxygen permeability coefficient of the pressure-sensitive adhesive layer is 200 cc/m²·day·atm or less.

10. The laminate according to claim 1,
wherein the laminate has a curved surface shape.

11. A manufacturing method of a laminate, which is a method for manufacturing the laminate according to claim 1, the manufacturing method comprising:
an alignment film-forming step of forming an alignment film on a base material using a composition for forming an alignment film;
a light absorption anisotropic layer-forming step of, after the alignment film-forming step, forming a light absorption anisotropic layer on the alignment film using a composition for forming a light absorption anisotropic layer, which contains a liquid crystal compound and a dichroic substance; and
a base material peeling step of, after the light absorption anisotropic layer-forming step, peeling off the base material to manufacture a laminate of the alignment film and the light absorption anisotropic layer.

12. The manufacturing method of a laminate according to claim 11,
wherein the composition for forming an alignment film contains a polymer compound, and
an absolute value of a difference between an SP value of the polymer compound and an SP value of the base material is 1.7 MPa^{1/2} or less.

13. The manufacturing method of a laminate according to claim 11,
wherein a viscosity of the composition for forming an alignment film at 25° C. is 2 mPa·s or more and less than 10 mPa·s.

14. The manufacturing method of a laminate according to claim 11,
wherein the alignment film-forming step includes a drying treatment of drying a coating film obtained by applying the composition for forming an alignment film onto the base material, the coating film having a concentration of solid contents of 60% or less, with wind having a wind speed of 2 m/s or less.

15. A virtual reality display apparatus comprising, in the following order:
an image display panel;
a first absorption type linear polarizer;
a first retardation layer;
a reflective type circular polarizer;
a half mirror;
a second retardation layer; and
a second absorption type linear polarizer,
wherein the second absorption type linear polarizer is the laminate according to claim 1.

16. The laminate according to claim 2,
wherein a content of the dichroic substance contained in the light absorption anisotropic layer is 40 to 250 mg/cm³.

17. The laminate according to claim 2,
wherein the alignment film contains a polymer compound, and
in a case where a secondary ion intensity derived from the polymer compound in the alignment film is measured by time-of-flight secondary ion mass spectrometry while irradiating the alignment film with an ion beam from a surface of the alignment film on a light absorption anisotropic layer side toward a surface opposite to the light absorption anisotropic layer, a maximum value of the secondary ion intensity derived from the polymer compound is present in a region from the surface opposite to the light absorption anisotropic layer to a position at a thickness of 100 nm.

18. The laminate according to claim 17,
wherein the polymer compound has a repeating unit represented by Formula (2), 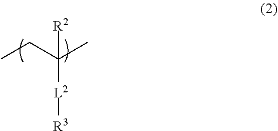
in Formula (2),
R² represents a hydrogen atom or an alkyl group having 1 to 4 carbon atoms,
L² represents a single bond or a divalent linking group,
R³ represents an aliphatic hydrocarbon group which may have a substituent or a group in which one or more of —CH₂-'s constituting the aliphatic hydrocarbon group are substituted with —O—, —S—, —NH—, —N(Q)-, or —CO—, and
Q represents a substituent.

19. The laminate according to claim 2, further comprising:
a protective layer on a side of the light absorption anisotropic layer opposite to the alignment film,
wherein an oxygen permeability coefficient of the protective layer is 200 cc/m²·day·atm or less.

20. The laminate according to claim 19,
wherein the protective layer consists of a polyvinyl alcohol-based resin film.
